(19) United States
(12) Patent Application Publication
(10) Pub. No.: US 2025/0191495 A1
(43) Pub. Date: Jun. 12, 2025

(54) Video and Audio with Sign Language Animation

(71) Applicant: Comcast Cable Communications, LLC, Philadelphia, PA (US)

(72) Inventors: Rameshkumar Ayyasamy Jayapal, Middletown, DE (US); Alex Barenbregge, Bedford, PA (US); Vishnu Govindan, Puducherry (IN)

(21) Appl. No.: 18/534,825

(22) Filed: Dec. 11, 2023

(51) Int. Cl. G09B 21/00; G10L 15/26

(52) U.S. Cl. CPC G09B 21/009; G10L 15/26

(57) ABSTRACT

A first device may communicate with a second device via a video or an audio using a network. The user of the second device may be hearing impaired. The video or the audio is converted to a sign language animation. The sign language animation is provided to the hearing-impaired user.

### BACKGROUND

Users communicate via video and/or voice over communication networks. Some users may be hearing impaired who may not hear at all or who may have a partial hearing loss.

### SUMMARY

The following summary presents a simplified summary of certain features. The summary is not an extensive overview and is not intended to identify key or critical elements.

Systems, apparatuses, and methods are described for generating sign language animation associated with a video (e.g., video voicemail, web conferencing, etc.) or an audio (e.g., audio voicemail). At least two users may communicate (e.g. by video or audio) over a network. The hearing impaired user may not be able to understand the video or the audio generated by another user. A process engine may convert the video or the audio into sign language animation and may provide the converted sign language animation to a hearing impaired user. The sign language animation may allow the hearing impaired users understanding conveyed messages from the video or the audio.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2A and FIG. 2B show hardware elements of a computing device.

FIG. 3A shows an example system of a video voicemail with sign language animation.

FIG. 3B shows an example system of a conference service with sign language animation.

FIG. 4 shows an example method of voicemail service.

FIG. 5A is a flowchart showing an example of generating sign language animation for a video.

FIG. 5B is a flowchart showing an example of generating sign language translation for a video.

FIG. 5C is a flowchart showing an example of generating sign language animation for an audio.

FIG. 5D is a table showing an example of metadata of a video object.

FIG. 5E is a table showing an example of metadata of an audio object.

FIG. 6A shows an example of video voicemail with sign language animation.

FIG. 6B shows an example of audio voicemail with sign language animation.

FIG. 7 shows an example of video voicemail with sign language translation.

FIG. 8 shows an example of web conferencing with sign language animation.

FIG. 9 shows an example of web conferencing with sign language translation.

FIG. 10 shows an example of web conferencing with sign language animation.

FIG. 11 shows an example of web conferencing with sign language translation.

FIG. 12A, FIG. 12B show examples of video voicemail with sign language animation preview.

FIG. 12C, FIG. 12D show examples of playing video voicemail with sign language animation to a hearing impaired user.

FIG. 12E shows an example of audio voicemail with sign language animation preview.

FIG. 13A, FIG. 13B, FIG. 13C, FIG. 13D show examples of video voicemail with sign language translation preview.

FIG. 14 shows an example of detecting sign language.

FIG. 15 shows an example of the preview of web conference video with sign language animation.

FIG. 16 shows an example of detecting sign language.

FIG. 17 shows an example of the preview of web conference video with sign language translation.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

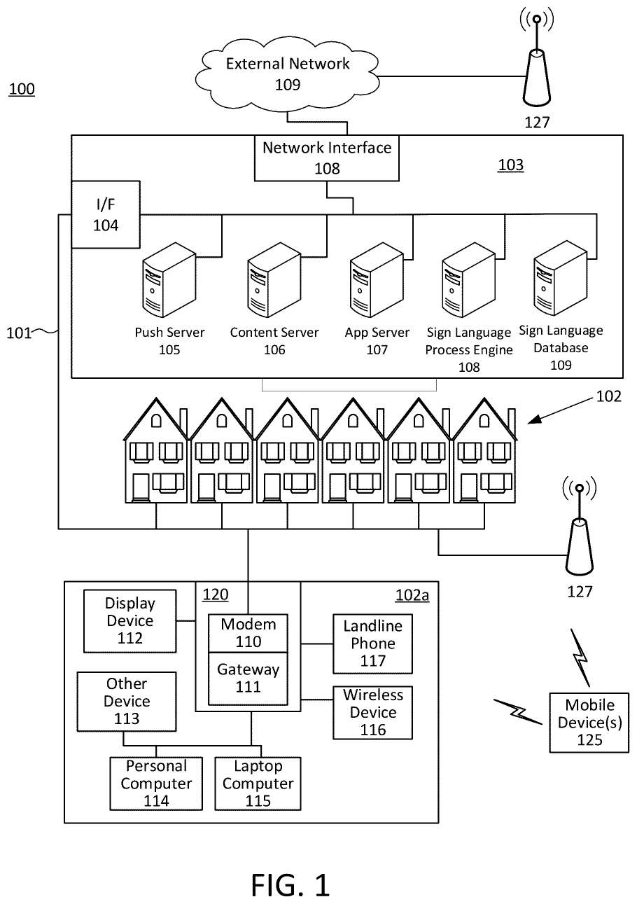

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107, sign language process engine 108 and sign language process engine 109, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as sign language process engine 108 and sign language database 109, additional push, content, and/or application servers, and/or other types of servers. The sign language process engine 108 may be configured to convert a video into sign language animation. The sign language database 109 may be configured to provide sign language symbols. Although shown separately, the push server 105, the content server 106, the application server 107, the sign language process engine 108 and the sign language database 109, and/or other server(s) may be combined. The servers 105-107, engine 108 and database 109, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

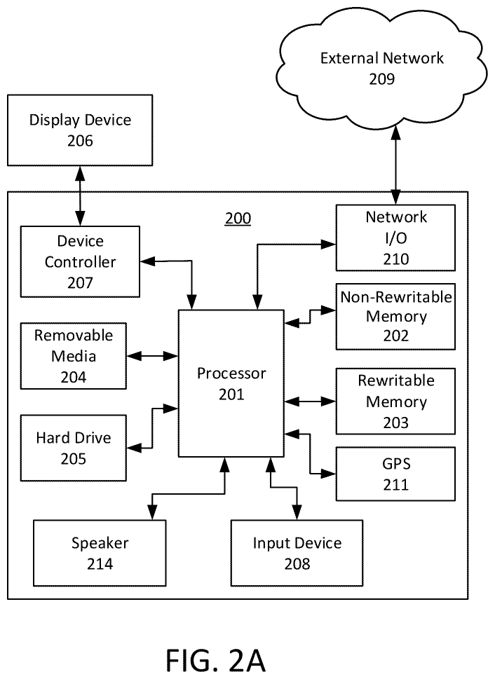

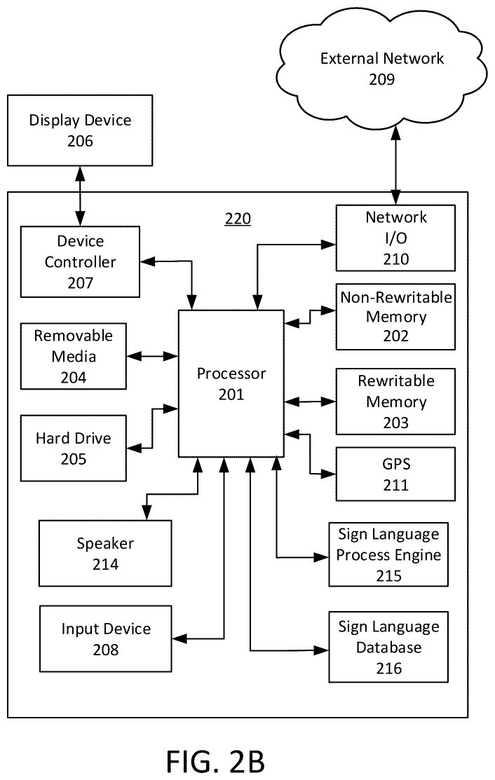

FIG. 2A shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein. The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, camera, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

FIG. 2B shows hardware elements of a computing device 220, which is similar to the computer device 200 with the additional of sign language process engine 215 and sign language database 216. The sign language process engine 215 may be software executed by the processor 201, and may be configured to convert a video into sign language animation. The sign language database 216 may be software executed by the processor 201, and may be configured to provide sign language symbols.

Although FIG. 2A and FIG. 2B show example hardware configurations, one or more of the elements of the computing device 200 or 220 may be implemented as software or a combination of hardware and software. Modifications may be made to add, remove, combine, divide, etc. components of the computing device 200 or 220. Additionally, the elements shown in FIG. 2A and FIG. 2B may be implemented using basic computing devices and components that have been configured to perform operations such as are described herein. For example, a memory of the computing device 200 or 220 may store computer-executable instructions that, when executed by the processor 201 and/or one or more other processors of the computing device 200 or 220, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

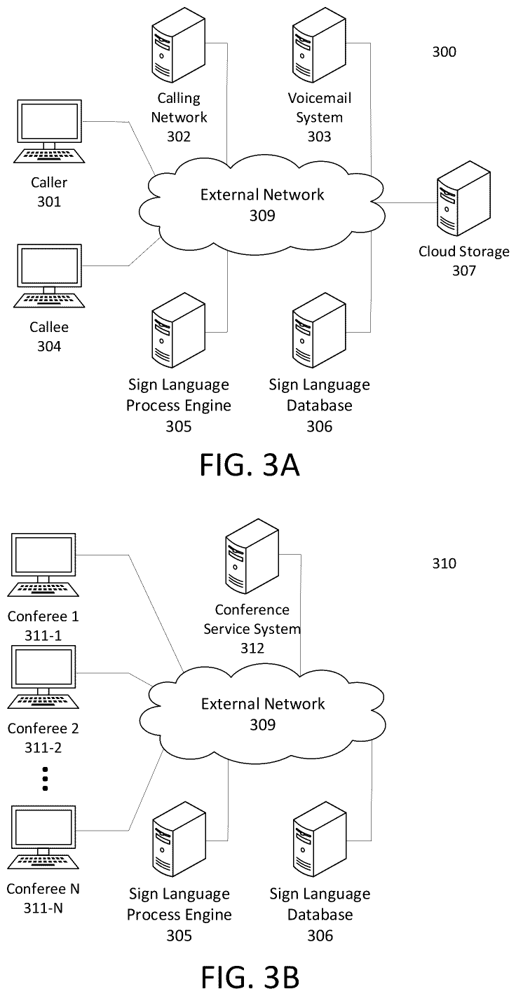

FIG. 3A shows an example system of a video voicemail with sign language animation in which features described herein may be implemented. System 300 may comprise caller 301, calling network 302, voicemail system 303, callee 304, sign language process engine 305, sign language database 306, cloud storage 307 and external network 309. FIG. 3A only shows an example of system 300 comprising a caller, a calling network, a voicemail system, a callee, a sign language process engine, a sign language database, a cloud storage and an external network, and is not limiting. The system 300 may comprise a plurality of callers, calling networks, voicemail systems, callees, sign language process engines, sign language databases, cloud storages and external networks. Each of the caller 301 and callee 304 may comprise the computing device 200 or 220 discussed above. The calling network 302 may be a network for video call and/or voice call. The video call may comprise video and/or voice communication. The calling network 302 may comprise the communication links 101 discussed above, the external network 109, an in-home network, a network provider's wireless, copper, coaxial, fiber, or hybrid fiber/coaxial distribution system (e.g., a DOCSIS network), or any other desired network. The caller 301 and callee 304 may conduct a video or voice call via the calling network 302. Each of the voicemail system 303, the sign language process engine 305, the sign language database 306 and the cloud storage 307 may comprise the computing device 200 discussed above. The external network 309 is used to connect the caller 301, the calling network 302, the voicemail system 303, the callee 304, the sign language process engine 305, the sign language database 306 and the cloud storage 307. The external network 309 may comprise the communication links 101 discussed above, the external network 109, an in-home network, a network provider's wireless, coaxial, fiber, or hybrid fiber/coaxial distribution system (e.g., a DOCSIS network), or any other desired network.

FIG. 3B shows an example system of a conference service with sign language animation in which features described herein may be implemented. System 310 may sign language process engine 305, sign language database 306, external network 309, conference service system 312 and conferees 311-1-311-N, where N may be great than or equal to 2. FIG. 3B only shows an example of system 310 comprising a sign language process engine, a sign language database, an external network and a conference service system, and is not limiting. The system 300 may comprise a plurality of sign language process engines, sign language databases, and external networks. Each of the conferees 311-1-311-N may comprise the computing device 200 or 220 discussed above. Each of the sign language process engine 305, sign language database 306 and conference service system 312 may comprise the computing device 200 discussed above. The external network 309 is used to connect the sign language process engine 305, the sign language database 306, conference service system 312 and conferees 311-1-311-N. The external network 309 may comprise the communication links 101 discussed above, the external network 109, an in-home network, a network provider's wireless, coaxial, fiber, or hybrid fiber/coaxial distribution system (e.g., a DOCSIS network), or any other desired network. The external network 309 may be a network for video conference and/or voice conference. The video conference may comprise video and/or voice communication.

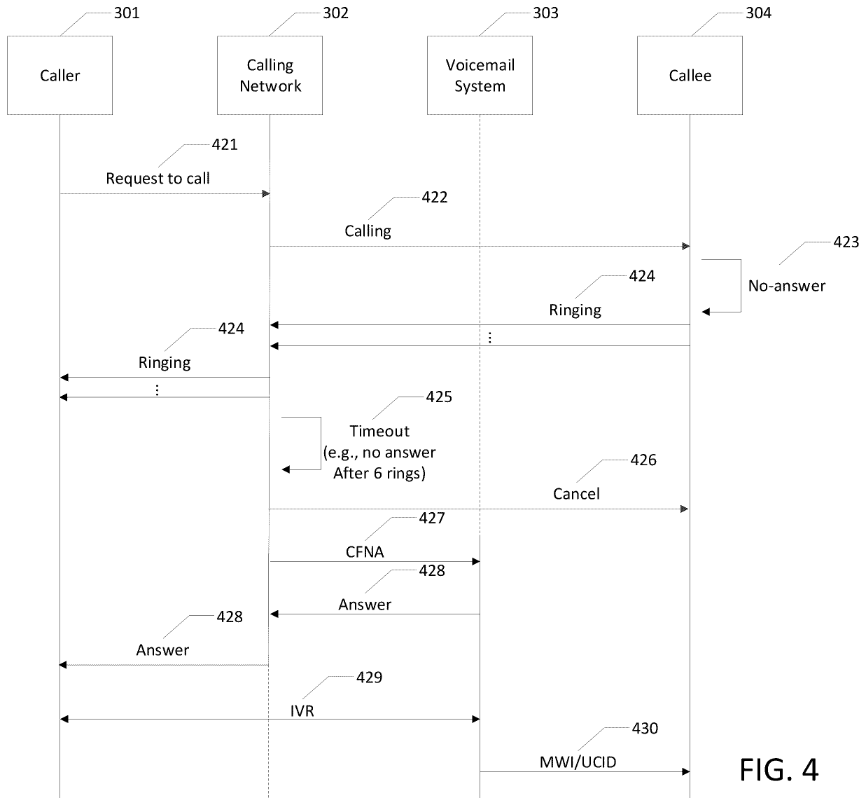

FIG. 4 shows an example method of voicemail service, according to embodiments of the disclosure. Caller 301 may send a request to call message 421 to calling network 302. The request to call message 421 may be for a video call or voice call with callee 304. The calling network 302 may generate and send a calling request message 422 to the callee 304 after the calling network 302 receives the request to call message 421. The no-answer event 423 occurs and may generate a ringing response message 424 if the callee 304 does not answer the calling request message 422 within a pre-predetermined period. The callee 304 may send the ringing response message 424 to the calling network 302. The calling network 302 may forward the ringing response message 424 to the caller 301. A second no-answer event 423 may occur if the callee 304 does not answer within the pre-predetermined period (after the first no-answer event). The callee 304 may send another ringing response message 424 to the calling network 302. The calling network 302 may forward another ringing response message 424 to the caller 301. The callee 304 may generate and send a plurality of ringing response messages if the callee 304 does not answer the video or voice call. A timeout event 425 may occur after: i) the callee does not answer the video or voice call; and/or ii) a plurality of ringing response messages 424 (e.g., 6 ringing response messages) received by the calling network 302. The timeout event 425 may occur if the callee 304 responds with a do-not-disturb message (not shown in FIG. 4) after receiving the calling request message 422. Based on the timeout event 425, the calling network 302 may send a cancellation message 426 to the callee 304 to end the request of the video call or voice call. The calling network 302 may send a call forward no answer (CFNA) message 526 to voicemail system 303 to initiate an interactive voice response (IVR) service 429 after sending the cancellation message 426. The voicemail system 303 may send an answer message 428 to the caller 301 via the calling network 302. The answer message 428 may notify the caller 301 that the IVR service 429 is initiated. The IVR service 429 may allow the caller 301 generating a video voicemail message or an audio voicemail message via a voice response system of pre-recorded messages. The video voicemail message may comprise video and/or audio. The voicemail system 303 may generate a voicemail waiting message and may send the voicemail waiting message to the callee 304. The voicemail waiting message may comprise a message waiting indicator (MWI) and a universal caller identifier (UCID). The MWI may inform the callee 304 about a status of video voicemail messages and/or audio voicemail messages. For example, the MWI may inform the callee 304 having the video voicemail message from the caller 301, where the caller 301 is indicated by the UCID. The callee 304 may be associated with a hearing impaired user who may not hear at all or may have a partial hearing loss. The hearing impaired user may not be able to understand the video voicemail message or the audio voicemail message generated by the caller 302.

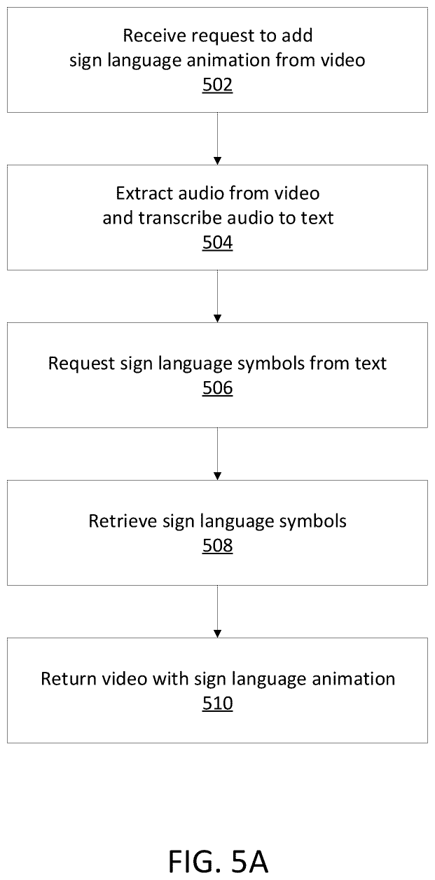

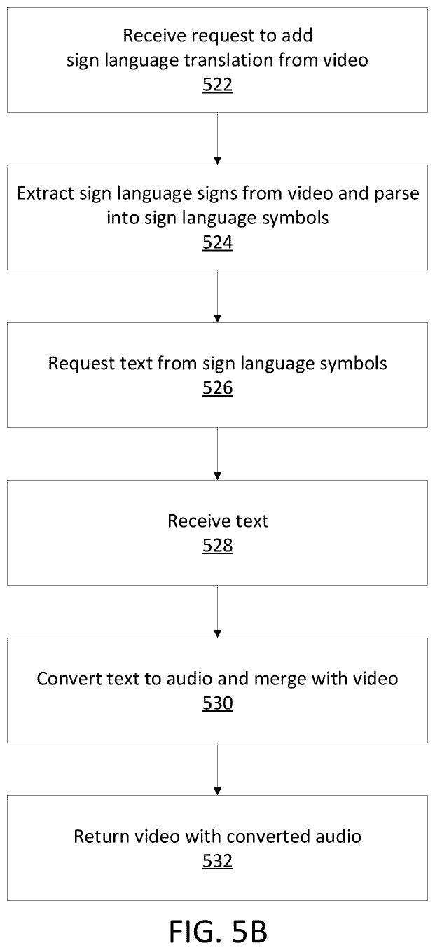

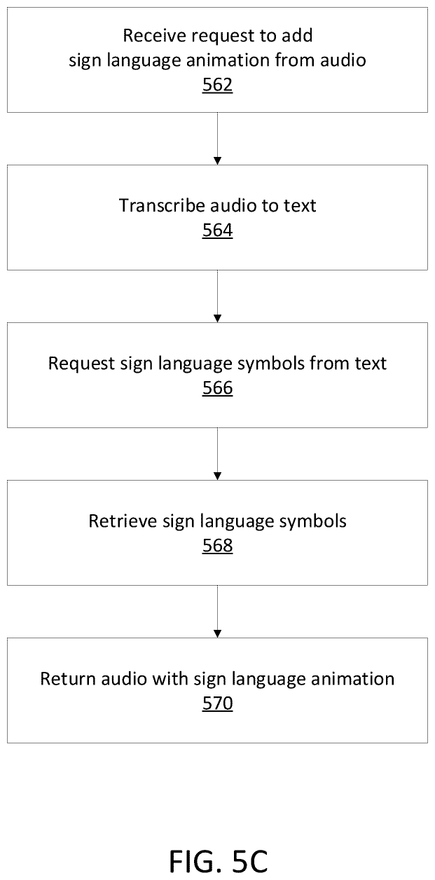

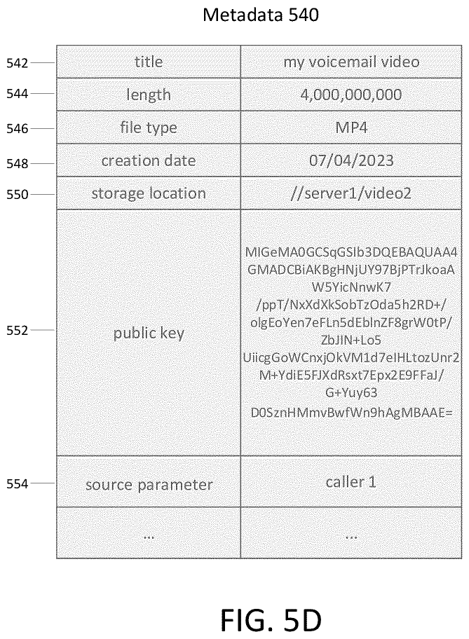

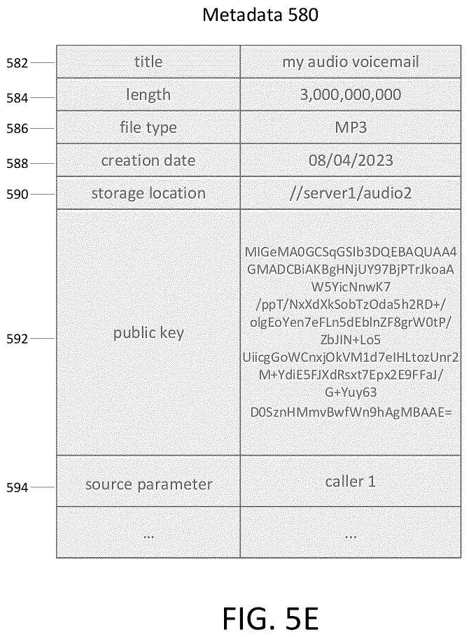

FIG. 5A is a flowchart showing an example of generating sign language animation for a video, according to embodiments of the disclosure. According to various embodiments, the example may be implemented by the system 300 shown in FIG. 3A. At 502, a process engine (e.g., sign language process engine 305 as shown in FIG. 3A and FIG. 3B) may receive, from a system (e.g., voicemail system 303 as shown in FIG. 3A, conference service system 312 as shown in FIG. 3B), a first request message to add sign language animation to a video object. The video object may be a pre-recorded video (e.g., a video voicemail) or a live video. The video object may comprise video and/or audio. The first request message may comprise an identifier of a user device and metadata of the video object. The identifier of the user device may indicate the user device (e.g., caller 301, callee 304 as shown in FIG. 3A, conferee 311-1, conferee 311-2, conferee 311-N as shown in FIG. 3B, etc.) requesting the adding of the sign language animation.

FIG. 5D shows an example of metadata of a video object. The metadata 540 of the video object may comprise a title 542, a length 544, file type 546, creation date 548, a storage location 550, a public key 552 and/or source parameter 554. The title 542 may indicate the title of the video object. The length 544 may indicate the length of the video object with a time unit (e.g., nanosecond). The file type 546 may indicate a file format of the video object (e.g., MP4, MOV, AVI, WMV, AVCHD, WebM, HTML5, FLV, MKV, MPEG-2, etc.) The creation date 548 may indicate a date which the video object is generated. The storage location 550 may indicate where the video object is currently stored. The video object may be currently stored at a local location (e.g., caller 301, callee 304, conferee 311-1, conferee 311-2, conferee 311-N, etc.) or a location different from the local location (e.g., a cloud storage, a file server, server farm, etc.). The public key 552 may be used to decrypt the video object if the video object is encrypted. The source parameter 554 may indicate the source(s) of the sign language (e.g., caller 301).

At 504, a process engine (e.g., sign language process engine 305) may extract an audio object from the video object and may transcribe the audio object to a text object. The process engine 305 may retrieve the video object based on the storage location. The storage location is determined based on the first request message from 502. The process engine 305 may decrypt the video object using the public key if the video object is encrypted. The process engine 305 may extract the audio object from the video object by separating an audio track from the video object based on the file type. The process engine 305 may extract the audio object by using multimedia framework (e.g., FFmpeg). The process engine 305 may transcribe the audio object to a text object by using natural language artificial intelligence (NLAI). The NLAI may draws on linguistic algorithms to sort auditory signals from the audio object and may transfer auditory signals into a text object, where the text object may comprise text characters. The audio object may be in at least one of languages, such as English, Spanish, French, Italian, Japanese, Chinese, etc. The transcribed text object may be in the same language of the audio object, and may be a different language from the audio object.

At 506, a process engine (e.g., sign language process engine 305) may request sign language symbols from the text object. The process engine 305 may send a second request message to a database (e.g., sign language database 306 as shown in FIG. 3A and FIG. 3B) for querying the database 306 to determine the sign language symbols. The second request message may comprise the transcribed text object in 504. The database 306 may be a database of lexical and phonological properties of sign language signs. The database 306 may search for the sign language symbols based on the text object in the second request. The database 306 may match the sign language symbols associated with at least one of sign languages (e.g., American sign language (ASL), Spanish sign language (SSL), French sign language, Italian sign language, Japanese sign language, Chinese sign language, etc.) The database 306 may return the matched sign language symbols to the process engine. The process engine 305 may retrieve the returned sign language symbols at 508.

At 510, a process engine (e.g., sign language process engine 305) may return the video object with sign language animation. The process engine 305 may generate sign language animated frames based on the received sign language symbols. The process engine 305 may generate the sign language animated frames by using multimedia framework (e.g., FFmpeg). The sign language animated frames may comprise pre-determined (e.g., default) features wherein the features may comprise templates, avatar, overlay, closed caption, type of sign language, etc. The process engine 305 may merge the sign language animated frames with the video object. The process engine 305 may merge the sign language animated frames by using Python library (e.g., MoviePy). The merged sign language animated frames with the video object may be previewed by the user device (e.g., caller 301, conferee 311-1, conferee 311-2, conferee 311-N, etc.) via an user interface (e.g., graphical user interface (GUI)). The features of the sign language animated frames may be adjusted by the user device. Based on the adjusted features, the process engine 305 may modify the sign language animated frames. The process engine 305 may return the video object with the modified sign language animation to the system, wherein the system 303/312 sends the first request message to the process engine in 502. The video object with the sign language animation is presented to at least one or more hearing impaired users through the system. The sign language animation allows the hearing impaired users to understand conveyed messages from the video object.

FIG. 5B is a flowchart showing an example of generating sign language translation for a video, where sign language signs from a video may be translated into audio, according to embodiments of the disclosure. The example may be implemented by the system 300 shown in FIG. 3A. At 522, a process engine (e.g., sign language process engine 305) may receive, from a system (e.g., voicemail system 303, conference service system 312), a first request message to add sign language translation to a video object. The video object may be a pre-recorded video (e.g., a video voicemail) or a live video. The video object may comprise video and/or audio. The video may comprise sign language signs. The first request message may comprise an identifier of a user device and metadata of the video object. The identifier of the user device may indicate the user device (e.g., caller 301, callee 304 as shown in FIG. 3A, conferee 311-1, conferee 311-2, conferee 311-N as shown in FIG. 3B, etc.) requesting the adding of the sign language translation. The metadata of the video object may comprise metadata similar to metadata 540 as described in FIG. 5D.

At 524, a process engine (e.g., sign language process engine 305) may extract sign language signs from the video object and may parse the extracted sign language signs into sign language symbols. The process engine 305 may retrieve the video object based on the storage location. The storage location is determined based on the first request message from 522. The process engine 305 may decrypt the video object using the public key if the video object is encrypted. The process engine 305 may extract sign language frames from the video object based on the file type. Based on the extracted sign language frames, the process engine 305 may determine sign language signs from individual gestures, including handshape, position of hands, and/or the movement of the hands. The process engine 305 may translate the sign language frames to sign language signs by using NLAI. The NLAI may draws on linguistic algorithms to identify sign language signals from the individual gestures of the sign language frames and may translate the sign language frames into sign language signs. The sign language frames may be in at least one of sign languages, such as American sign language (ASL), Spanish sign language (SSL), French sign language, Italian sign language, Japanese sign language, Chinese sign language, etc. The translated sign language signs may be in the same language of the sign language frames, and may be a different language from the sign language frames. The process engine 305 may parse the sign language signs into sign language symbols.

At 526, a process engine (e.g., sign language process engine 305) may request a text object from the parsed sign language symbols at 524. The process engine 305 may send a second request message to a database (e.g., sign language database 306) for querying the database 306 to determine the text object, where the text object may comprise text characters. The second request message may comprise the parsed sign language symbols in 524. The database 306 may be a database of lexical and phonological properties of sign language signs. The database 306 may search for the text object based on the sign language signs in the second request. The database 306 may match the text object associated with at least one of sign languages (e.g., American sign language (ASL), Spanish sign language (SSL), French sign language, Italian sign language, Japanese sign language, Chinese sign language, etc.) The database 306 may return the matched text object to the process engine 305. The process engine may retrieve the returned text object at 528.

At 530, a process engine (e.g., sign language process engine 305) may convert the text object into an audio object and merge it with the video object. The process engine 305 may convert the text object (from 528) to the audio object by using NLAI. The NLAI may draws on linguistic algorithms to sort text characters from the text object and may transfer the text characters into the audio object. The audio object may comprise pre-determined (e.g., default) features, wherein the features may comprise templates, avatar, overlay, closed caption, type of language, etc. The text object may be in at least one of languages, such as English, Spanish, French, Italian, Japanese, Chinese, etc. The converted audio object may be in the same language of the text object, and may be a different language from the text object. The process engine 305 may merge the audio object with the video object. The process engine 305 may merge the audio object by using Python library (e.g., MoviePy). The merged audio object with the video object may be previewed by the user device (e.g., caller 301, callee 304, conferee 311-1, conferee 311-2, conferee 311-N, etc.) via an user interface (e.g., graphical user interface (GUI)). The features of the audio object may be adjusted by the user device. Based on the adjusted features, the process engine 305 may modify the audio object. The process engine 305 may return the video object with the modified audio object to the system, wherein the system sends the first request message to the process engine 305 at 532. The video object with the sign language translation is presented to at least one or more users who may not understand sign language messages provided from hearing impaired users. The sign language translation allows the non-sign-language users to understand the conveyed message from the sign language video.

FIG. 5C is a flowchart showing an example of generating sign language animation for an audio, according to embodiments of the disclosure. According to various embodiments, the example may be implemented by the system 300 shown in FIG. 3A. At 562, a process engine (e.g., sign language process engine 305 as shown in FIG. 3A and FIG. 3B) may receive, from a system (e.g., voicemail system 303 as shown in FIG. 3A, conference service system 312 as shown in FIG. 3B), a first request message to add sign language animation to an audio object. The audio object may be a pre-recorded audio (e.g., an audio voicemail) or a live audio. The first request message may comprise an identifier of a user device and metadata of the audio object. The identifier of the user device may indicate the user device (e.g., caller 301, callee 304 as shown in FIG. 3A, conferee 311-1, conferee 311-2, conferee 311-N as shown in FIG. 3B, etc.) requesting the adding of the sign language animation.

FIG. 5E shows an example of metadata of an audio object. The metadata 580 of the audio object may comprise a title 582, a length 584, file type 586, creation date 588, a storage location 590, a public key 592 and/or source parameter 594. The title 582 may indicate the title of the audio object. The length 584 may indicate the length of the audio object with a time unit (e.g., nanosecond). The file type 586 may indicate a file format of the audio object (e.g., WAV, AIFF, AU, PCM, FLAC, TTA, ATRAC, ALAC, WMA, SHN, Opus, MP3, Vorbis, Musepack, AAC, ATRA, etc.) The creation date 588 may indicate a date which the audio object is generated. The storage location 590 may indicate where the audio object is currently stored. The audio object may be currently stored at a local location (e.g., caller 301, callee 304, conferee 311-1, conferee 311-2, conferee 311-N, etc.) or a location different from the local location (e.g., a cloud storage, a file server, server farm, etc.). The public key 592 may be used to decrypt the audio object if the audio object is encrypted. The source parameter 594 may indicate the source(s) of the sign language (e.g., caller 301).

At 564, a process engine (e.g., sign language process engine 305) may transcribe the audio object to a text object. The process engine 305 may retrieve the audio object based on the storage location. The storage location is determined based on the first request message from 562. The process engine 305 may decrypt the audio object using the public key if the audio object is encrypted. The process engine 305 may transcribe the audio object to a text object by using natural language artificial intelligence (NLAI). The NLAI may draws on linguistic algorithms to sort auditory signals from the audio object and may transfer auditory signals into a text object, where the text object may comprise text characters. The audio object may be in at least one of languages, such as English, Spanish, French, Italian, Japanese, Chinese, etc. The transcribed text object may be in the same language of the audio object, and may be a different language from the audio object.

At 566, a process engine (e.g., sign language process engine 305) may request sign language symbols from the text object. The process engine 305 may send a second request message to a database (e.g., sign language database 306 as shown in FIG. 3A and FIG. 3B) for querying the database 306 to determine the sign language symbols. The second request message may comprise the transcribed text object in 564. The database 306 may be a database of lexical and phonological properties of sign language signs. The database 306 may search for the sign language symbols based on the text object in the second request. The database 306 may match the sign language symbols associated with at least one of sign languages (e.g., American sign language (ASL), Spanish sign language (SSL), French sign language, Italian sign language, Japanese sign language, Chinese sign language, etc.) The database 306 may return the matched sign language symbols to the process engine. The process engine 305 may retrieve the returned sign language symbols at 568.

At 570, a process engine (e.g., sign language process engine 305) may return the audio object with sign language animation. The process engine 305 may generate sign language animated frames based on the received sign language symbols. The process engine 305 may generate the sign language animated frames by using multimedia framework (e.g., FFmpeg). The sign language animated frames may comprise pre-determined (e.g., default) features wherein the features may comprise templates, avatar, overlay, closed caption, type of sign language, etc. The process engine 305 may merge the sign language animated frames with the audio object. The process engine 305 may merge the sign language animated frames by using Python library (e.g., MoviePy). The merged sign language animated frames with the audio object may be previewed by the user device (e.g., caller 301, conferee 311-1, conferee 311-2, conferee 311-N, etc.) via an user interface (e.g., graphical user interface (GUI)). The features of the sign language animated frames may be adjusted by the user device. Based on the adjusted features, the process engine 305 may modify the sign language animated frames. The process engine 305 may return the audio object with the modified sign language animation to the system, wherein the system 303/312 sends the first request message to the process engine in 502. The audio object with the sign language animation is presented to at least one or more hearing impaired users through the system. The sign language animation allows the hearing impaired users to understand conveyed messages from the audio object.

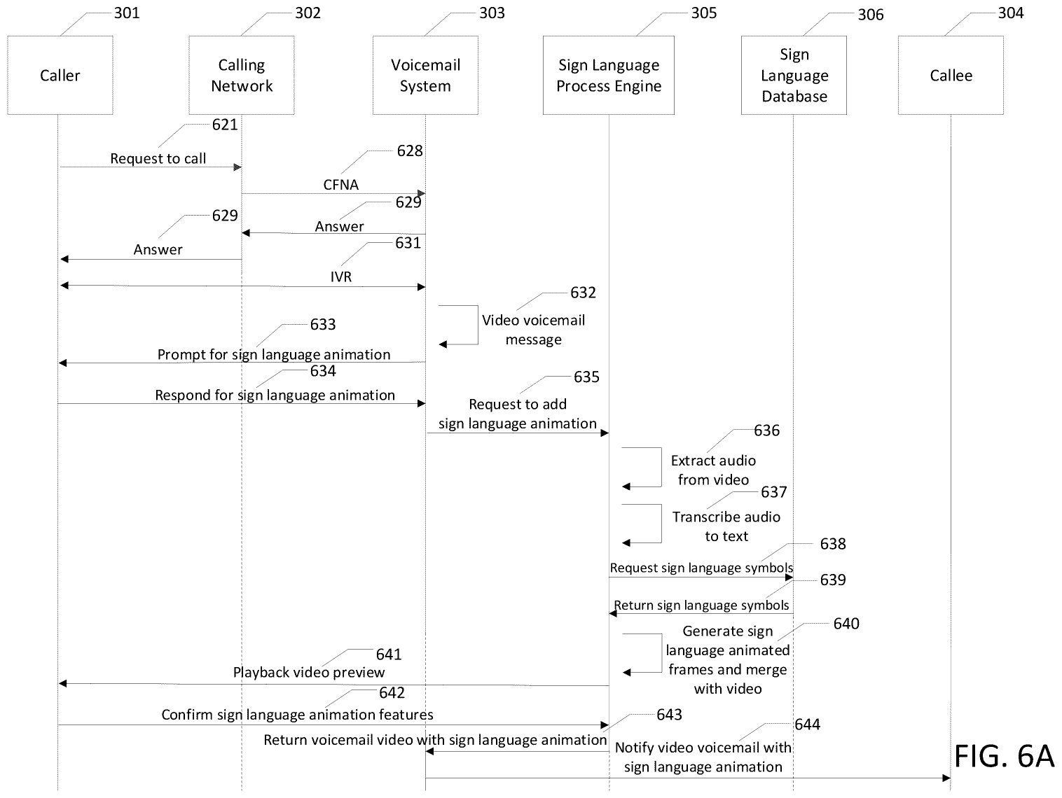

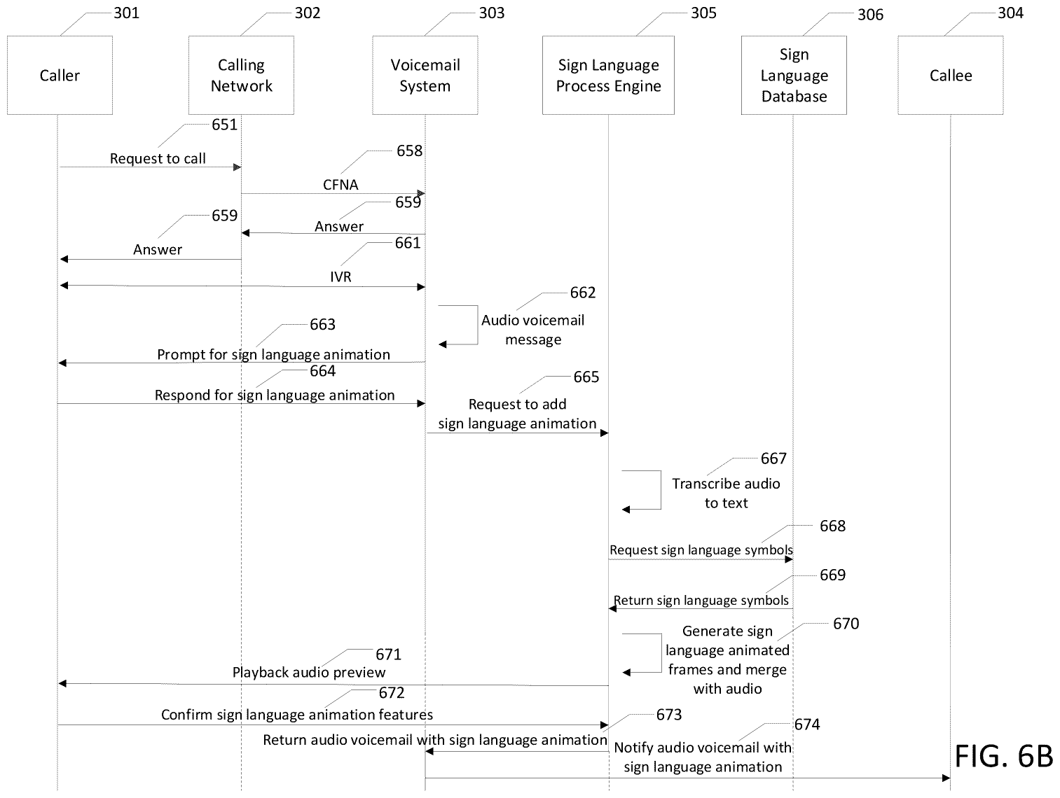

FIG. 6A shows an example of video voicemail with sign language animation according to embodiments of the disclosure. The example may be implemented by the system 300 shown in FIG. 3A. Additionally, the example of FIG. 6A may be an enhancement of the voicemail example of FIG. 4. Similar to FIG. 4, caller 301 may send a first request message to call message 621 to calling network 302. The first request message to call message 621 may be for a video call or voice call with callee 304. A timeout event may occur after i) the callee does not answer the video or voice call; and/or ii) a plurality of ringing response messages (e.g., 6 ringing response messages) received by the calling network 302. The timeout event may occur (not shown on FIG. 6A) if the callee 304 responds with a do-not-disturb message (not shown in FIG. 6A) after receiving the calling request message. Based on the timeout event, the calling network 302 may send a call forward no answer (CFNA) message 628 to voicemail system 303 to initiate an interactive voice response (IVR) service 631. The IVR service 631 may allow the caller 301 generating a video voicemail message via a voice response system of pre-recorded messages. The voicemail system 303 may store video voicemail message 632 at a local location (e.g., caller 301) or a location different from the local location (e.g., a cloud storage, a file server, server farm, etc.). The video voicemail message 632 may comprise a video object.

Voicemail system 303 may send a prompt 633 for sign language animation to the caller 301 after the video voicemail message is stored. The caller 301 may respond to the prompt 634 whether the caller 301 select sign language animation. The voicemail system 303 may generate a voicemail waiting message and may send the voicemail waiting message to the callee 304 (not shown in FIG. 6A), if the caller 301 does not select the sign language animation. The voicemail system 303 may generate a second request to add sign language animation 635 and may send the second request to add sign language animation to sign language process engine 305, if the caller selects the sign language animation. The second request message may comprise an identifier of the caller 301 and metadata of the video object. The metadata of the video object may comprise metadata similar to metadata 540 as described in FIG. 5D.

Sign language process engine 305 may extract an audio object from the video object 636 and may transcribe the audio object to a text object 637. The sign language process engine 305 may retrieve the video object based on the storage location. The storage location is determined based on the second request message 635. The sign language process engine 305 may decrypt the video object using the public key if the video object is encrypted. The sign language process engine 305 may extract the audio object from the video object by separating an audio track from the video object based on the file type. The process engine 305 may transcribe the audio object to a text object by using NLAI. The NLAI may draws on linguistic algorithms to sort auditory signals from the audio object and may transfer auditory signals into a text object, where the text object may comprise text characters. The audio object may be in at least one of languages, such as English, Spanish, French, Italian, Japanese, Chinese, etc. The transcribed text object may be in the same language of the audio object, and may be a different language from the audio object.

Sign language process engine 305 may request sign language symbols from the text object. The process engine 305 may send a third request message 638 to sign language database 306 for querying the database 306 to determine the sign language symbols. The third request message may comprise the transcribed text object. The database 306 may be a database of lexical and phonological properties of sign language signs. The database 306 may search for the sign language symbols based on the text object in the second request. The database 306 may match the sign language symbols associated with at least one of sign languages (e.g., American sign language (ASL), Spanish sign language (SSL), French sign language, Italian sign language, Japanese sign language, Chinese sign language, etc.) The database 306 may return the matched sign language symbols 639 to the sign language process engine 305.

Sign language process engine 305 may generate sign language animated frames 640 based on the received sign language symbols. The sign language animated frames may comprise pre-determined (e.g., default) features wherein the features may comprise templates, avatar, overlay, closed caption, type of sign language, etc. The process engine 305 may merge the sign language animated frames with the video object. The merged sign language animated frames with the video object may be previewed 641 by the caller 301 via an user interface (e.g., graphical user interface (GUI)), based on the identifier of the caller 301 from the message 635. The features of the sign language animated frames may be adjusted and confirmed 642 by the caller 301. Based on the adjusted and confirmed features, the sign language process engine 305 may modify the sign language animated frames. The sign language process engine 305 may return the video object with the modified sign language animation 643 to the voicemail system 303. The voicemail system 303 may generate a voicemail waiting message and may send the voicemail waiting message 644 to the callee 304. The voicemail waiting message may comprise a message waiting indicator (MWI) and a universal caller identifier (UCID). The MWI may inform the callee 304 about a status of video voicemail messages. For example, the MWI may inform the callee 304 having the video voicemail message from the caller 301, where the caller 301 is indicated by the UCID. The video object with the sign language animation is presented to at least one or more hearing impaired users through the system. The sign language animation allows the hearing impaired users to understand conveyed messages from the video object.

FIG. 6B shows an example of audio voicemail with sign language animation according to embodiments of the disclosure. The example may be implemented by the system 300 shown in FIG. 3A. Additionally, the example of FIG. 6B may be an enhancement of the voicemail example of FIG. 4. Similar to FIG. 4, caller 301 may send a first request message to call message 651 to calling network 302. The first request message to call message 651 may be for a video call or voice call with callee 304. A timeout event may occur after i) the callee does not answer the video or voice call; and/or ii) a plurality of ringing response messages (e.g., 6 ringing response messages) received by the calling network 302. The timeout event may occur (not shown on FIG. 6B) if the callee 304 responds with a do-not-disturb message (not shown in FIG. 6B) after receiving the calling request message. Based on the timeout event, the calling network 302 may send a call forward no answer (CFNA) message 658 to voicemail system 303 to initiate an interactive voice response (IVR) service 661. The IVR service 661 may allow the caller 301 generating an audio voicemail message via a voice response system of pre-recorded messages. The voicemail system 303 may store audio voicemail message 662 at a local location (e.g., caller 301) or a location different from the local location (e.g., a cloud storage, a file server, server farm, etc.). The audio voicemail message 662 may comprise an audio object.

Voicemail system 303 may send a prompt 663 for sign language animation to the caller 301 after the audio voicemail message is stored. The caller 301 may respond to the prompt 664 whether the caller 301 select sign language animation. The voicemail system 303 may generate a voicemail waiting message and may send the voicemail waiting message to the callee 304 (not shown in FIG. 6B), if the caller 301 does not select the sign language animation. The voicemail system 303 may generate a second request to add sign language animation 665 and may send the second request to add sign language animation to sign language process engine 305, if the caller selects the sign language animation. The second request message may comprise an identifier of the caller 301 and metadata of the audio object. The metadata of the audio object may comprise metadata similar to metadata 580 as described in FIG. 5E.

Sign language process engine 305 may transcribe the audio object to a text object 667. The sign language process engine 305 may retrieve the audio object based on the storage location. The storage location is determined based on the second request message 665. The sign language process engine 305 may decrypt the audio object using the public key if the audio object is encrypted. The process engine 305 may transcribe the audio object to a text object by using NLAI. The NLAI may draws on linguistic algorithms to sort auditory signals from the audio object and may transfer auditory signals into a text object, where the text object may comprise text characters. The audio object may be in at least one of languages, such as English, Spanish, French, Italian, Japanese, Chinese, etc. The transcribed text object may be in the same language of the audio object, and may be a different language from the audio object.

Sign language process engine 305 may request sign language symbols from the text object. The process engine 305 may send a third request message 668 to sign language database 306 for querying the database 306 to determine the sign language symbols. The third request message may comprise the transcribed text object. The database 306 may be a database of lexical and phonological properties of sign language signs. The database 306 may search for the sign language symbols based on the text object in the second request. The database 306 may match the sign language symbols associated with at least one of sign languages (e.g., American sign language (ASL), Spanish sign language (SSL), French sign language, Italian sign language, Japanese sign language, Chinese sign language, etc.) The database 306 may return the matched sign language symbols 669 to the sign language process engine 305.

Sign language process engine 305 may generate sign language animated frames 670 based on the received sign language symbols. The sign language animated frames may comprise pre-determined (e.g., default) features wherein the features may comprise templates, avatar, overlay, closed caption, type of sign language, etc. The process engine 305 may merge the sign language animated frames with the audio object. The merged sign language animated frames with the audio object may be previewed 671 by the caller 301 via an user interface (e.g., graphical user interface (GUI)), based on the identifier of the caller 301 from the message 665. The features of the sign language animated frames may be adjusted and confirmed 672 by the caller 301. Based on the adjusted and confirmed features, the sign language process engine 305 may modify the sign language animated frames. The sign language process engine 305 may return the audio object with the modified sign language animation 673 to the voicemail system 303. The voicemail system 303 may generate a voicemail waiting message and may send the voicemail waiting message 674 to the callee 304. The voicemail waiting message may comprise a message waiting indicator (MWI) and a universal caller identifier (UCID). The MWI may inform the callee 304 about a status of audio voicemail messages. For example, the MWI may inform the callee 304 having the audio voicemail message from the caller 301, where the caller 301 is indicated by the UCID. The audio object with the sign language animation is presented to at least one or more hearing impaired users through the system. The sign language animation allows the hearing impaired users to understand conveyed messages from the audio object.

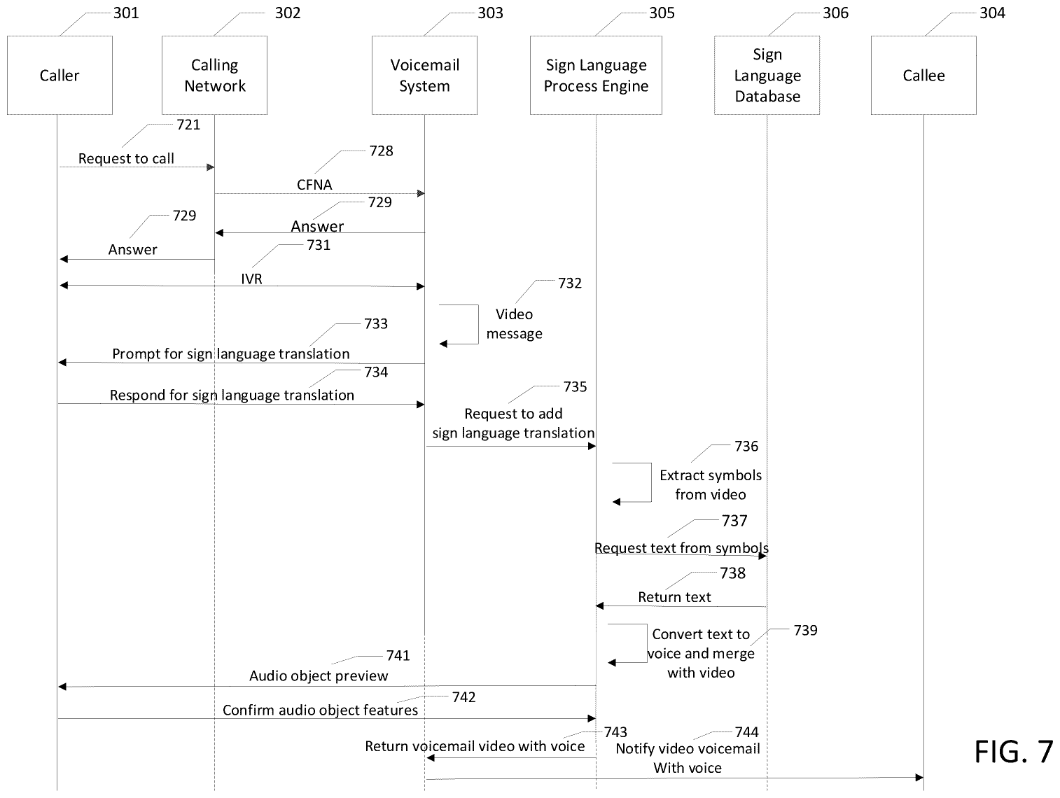

FIG. 7 shows an example of video voicemail with sign language translation, where sign language signs from video voicemail may be translated into audio, according to embodiments of the disclosure. The example may be implemented by the system 300 shown in FIG. 3A. Caller 301 may send a first request message to call message 721 to calling network 302. The first request message to call message 721 may be for a video call or voice call with callee 304. A timeout event may occur after i) the callee does not answer the video or voice call; and/or ii) a plurality of ringing response messages (e.g., 6 ringing response messages) received by the calling network 302. The timeout event may occur (not shown on FIG. 7) if the callee 304 responds with a do-not-disturb message (not shown in FIG. 6A) after receiving the calling request message. Based on the timeout event, the calling network 302 may send a call forward no answer (CFNA) message 728 to voicemail system 303 to initiate an interactive voice response (IVR) service 731. The IVR service 731 may allow the caller 301 generating a video voicemail message via a voice response system of pre-recorded messages. The voicemail system 303 may store video voicemail message 732 at a local location (e.g., caller 301) or a location different from the local location (e.g., a cloud storage, a file server, server farm, etc.). The video voicemail message 732 may comprise a video object.

Voicemail system 303 may send a prompt 733 for sign language translation to the caller 301 after the video voicemail message is stored. The caller 301 may respond 734 to the prompt whether the caller 301 select sign language translation. The voicemail system 303 may generate a voicemail waiting message and may send the voicemail waiting message to the callee 304 (not shown in FIG. 7), if the caller 301 does not select the sign language translation. The voicemail system 303 may generate a second request to add sign language translation 735 and may send the second request to add sign language translation to sign language process engine 305, if the caller selects the sign language translation. The second request message may comprise an identifier of the caller 301 and metadata of the video object. The metadata of the video object may comprise metadata similar to metadata 540 as described in FIG. 5D.

Sign language process engine 305 may receive, from voicemail system 303, a second request message to add sign language translation to a video object. The video object may be a pre-recorded video (e.g., a video voicemail) or a live video. The video object may comprise video and/or audio. The video may comprise sign language signs. The second request message may comprise an identifier of the caller 301 and metadata of the video object. The metadata of the video object may comprise metadata similar to metadata 540 as described in FIG. 5D.

Sign language process engine 305 may extract sign language signs from the video object and may parse the extracted sign language signs into sign language symbols 736. The sign language process engine 305 may retrieve the video object based on the storage location. The storage location is determined based on the first request message 735. The sign language process engine 305 may decrypt the video object using the public key if the video object is encrypted. The sign language process engine 305 may extract sign language frames from the video object based on the file type. Based on the extracted sign language frames, the sign language process engine 305 may determine sign language signs from individual gestures, including handshape, position of hands, and/or the movement of the hands. The process engine may translate the sign language frames to sign language signs by using NLAI. The NLAI may draws on linguistic algorithms to identify sign language signals from the individual gestures of the sign language frames and may translate the sign language frames into sign language signs. The sign language frames may be in at least one of sign languages, such as American sign language (ASL), Spanish sign language (SSL), French sign language, Italian sign language, Japanese sign language, Chinese sign language, etc. The translated sign language signs may be in the same language of the sign language frames, and may be a different language from the sign language frames. The sign language process engine 305 may parse the sign language signs into sign language symbols.

Sign language process engine 305 may request (e.g., query for) a text object from the parsed sign language symbols. The sign language process engine 305 may send a second request message 737 to a database (e.g., sign language database 306) for querying the database 306 to determine the text object, where the text object may comprise text characters. The second request message may comprise the parsed sign language symbols. The database 306 may be a database of lexical and phonological properties of sign language signs. The database 306 may search for the text object based on the sign language signs in the second request. The database may match the text object associated with at least one of sign languages (e.g., American sign language (ASL), Spanish sign language (SSL), French sign language, Italian sign language, Japanese sign language, Chinese sign language, etc.) The sign language database 306 may return the matched text object 738 to the sign language process engine 305. The sign language process engine 305 may retrieve the returned text object.

Sign language process engine 305 may convert the text object into an audio object and merge the audio object with the video object 739. The sign language process engine 305 may convert the text object to the audio object by using NLAI. The NLAI may draws on linguistic algorithms to sort text characters from the text object and may transfer the text characters into the audio object. The audio object may comprise pre-determined (e.g., default) features, wherein the features may comprise templates, avatar, overlay, closed caption, type of language, etc. The text object may be in at least one of languages, such as English, Spanish, French, Italian, Japanese, Chinese, etc. The converted audio object may be in the same language of the text object, and may be a different language from the text object. The sign language process engine 305 may merge the converted audio object with the video object. The sign language process engine 305 may replace a portion of audio track of the video object with the audio object. The merged audio object with the video object may be previewed 741 by the caller 301 via an user interface (e.g., graphical user interface (GUI)), based on the identifier of the caller 301 from the message 735. The features of the audio object may be adjusted and confirmed by the user device. Based on the adjusted features, the sign language process engine 305 may modify the audio object. The sign language process engine 305 may return the video object with the modified audio object 743 to the voicemail system 303. The voicemail system 303 may generate a voicemail waiting message and may send the voicemail waiting message 744 to the callee 304. The voicemail waiting message may comprise a message waiting indicator (MWI) and a universal caller identifier (UCID). The MWI may inform the callee 304 about a status of video voicemail messages. For example, the MWI may inform the callee 304 having the video voicemail message from the caller 301, where the caller 301 is indicated by the UCID. The video object with the sign language translation in audio is presented to at least one or more users who may not understand sign language messages provided from hearing impaired users. The sign language translation allows the non-sign-language users to understand the conveyed message from the sign language video.

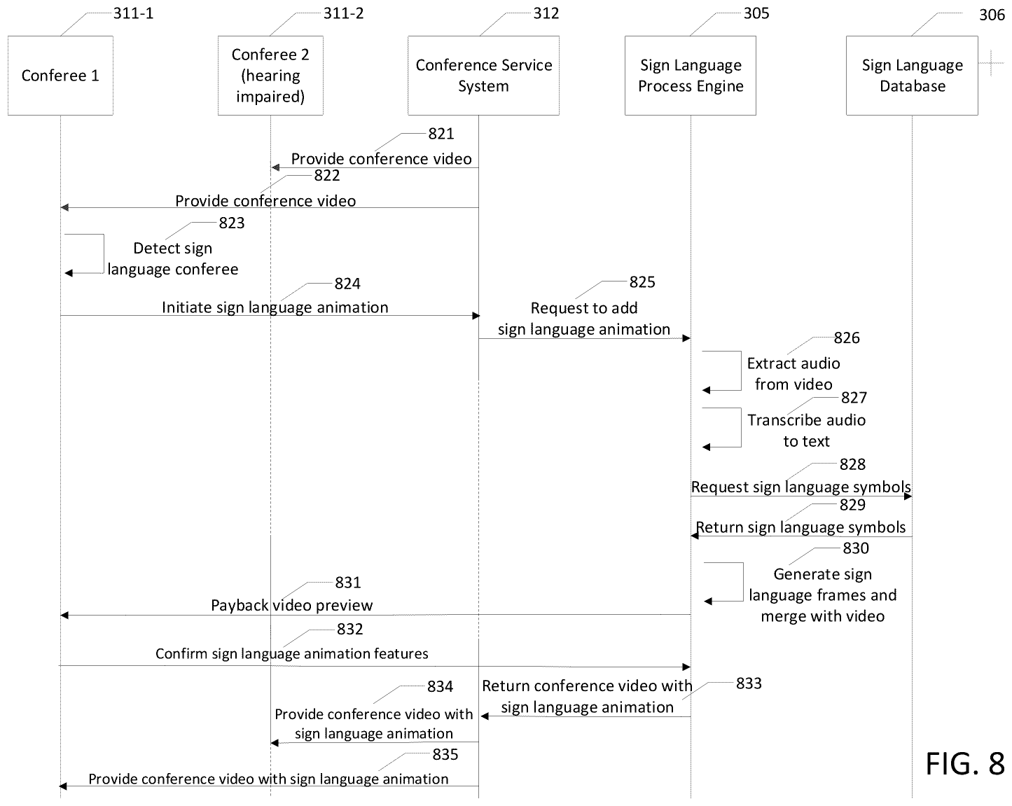

FIG. 8 shows an example of web conferencing with sign language animation according to embodiments of the disclosure. The example may be implemented by the system 310 shown in FIG. 3B. Conference service system may receive a video feed from each of conferee 1 (311-1) and conferee 2 (311-2). The example is not limiting to two conferees and the conference service system may provide the conference video to N conferees (N=>2). Conferee 2 may be associated with a hearing impaired user who may communicate via sign language in the video feed. Each video feed may comprise video and/or audio. The conference service system may combine at least a portion of video feeds from the conferees, and may generate a conference video from the combined video feeds. The combined video feeds may include identifiers of the conferees. The conference service system may provide a video object (e.g., conference video 821, 822) to the conferee 1(311-1) and the conferee 2(311-2). The video object may comprise the video and/or audio of each video feed from each conferee. The conferee 1 (311-1) may manually or automatically detect a sign language conferee 823. The user of the conferee 1 (311-1) may manually detect sign language from the video object (e.g., viewing sign language signs). The conferee 1 (311-1) may automatically detect sign language by using NLAI. The conferee 1 (311-1) may be prompted for sign language animation if a sign language conferee is detected (e.g. conferee communicating via sign language). The conferee 1 (311-1) may send a message 824 for initiating sign language animation to the conference service system 312 if conferee 1 (311-1) selects the sign language animation. The message 824 may include a parameter indicating the source of the sign language (e.g., conferee 2 (311-2)). The conference service system 312 may generate a first request message to add sign language animation 825 and may send the first request message 825 to sign processing engine 305 after receiving the message 824. The first request message may comprise an identifier of initiator (e.g., the conferee 1 (311-1) and metadata of the video object. The metadata of the video object may comprise metadata similar to metadata 540 as described in FIG. 5D.

Sign language process engine 305 may extract an audio object from the video object 826 and may transcribe the audio object to a text object 827. The sign language process engine 305 may retrieve the video object based on the storage location. The storage location is determined based on the first request message 825. The sign language process engine 305 may decrypt the video object using the public key if the video object is encrypted. The sign language process engine 305 may extract the audio object from the video object by separating an audio track from the video object based on the source parameter. The sign language process engine 305 may skip the audio track from the conferee(s) identified by the source parameter. For example, the sign language process engine 305 may skip the audio track from conferee 2 (311-2) and may extract the audio track from conferee 1 (311-1). The process engine may transcribe the audio object to a text object by using NLAI. The NLAI may draws on linguistic algorithms to sort auditory signals from the audio object and may transfer auditory signals into a text object, where the text object may comprise text characters. The audio object may be in at least one of languages, such as English, Spanish, French, Italian, Japanese, Chinese, etc. The transcribed text object may be in the same language of the audio object, and may be a different language from the audio object.

Sign language process engine 305 may request sign language symbols from the text object. The process engine may send a second request message 828 to sign language database 306 for querying the database 306 to determine the sign language symbols. The second request message may comprise the transcribed text object. The database 306 may be a database of lexical and phonological properties of sign language signs. The database 306 may search for the sign language symbols based on the text object in the second request. The database 306 may match the sign language symbols associated with at least one of sign languages (e.g., American sign language (ASL), Spanish sign language (SSL), French sign language, Italian sign language, Japanese sign language, Chinese sign language, etc.) The database 306 may return the matched sign language symbols 829 to the sign language process engine 305.

Sign language process engine 305 may generate sign language animated frames based on the received sign language symbols. The sign language animated frames may comprise pre-determined (e.g., default) features wherein the features may comprise templates, avatar, overlay, closed caption, type of sign language, etc. The process engine may merge the sign language animated frames with the video object. The merged sign language animated frames with the video object may be previewed 831 by the initiator (the conferee 1 (311-1)) via an user interface (e.g., graphical user interface (GUI)), based on the identifier of the initiator from the message 825. The features of the sign language animated frames may be adjusted and confirmed 832 by the conferee 1 (311-1). Based on the adjusted and confirmed features, the sign language process engine 305 may modify the sign language animated frames. The sign language process engine 305 may return the video object with the modified sign language animation 833 to the conference service system 312. The conference service system may provide the video object with the modified sign language animation (834, 835) to the conferee 1(311-1) and the conferee 2 (311-2) respectively. The video object with the sign language animation is presented to at least one or more hearing impaired users (e.g., the conferee 2 (311-2)) through the system. The sign language animation allows the hearing impaired users to understand conveyed messages from the web conference.

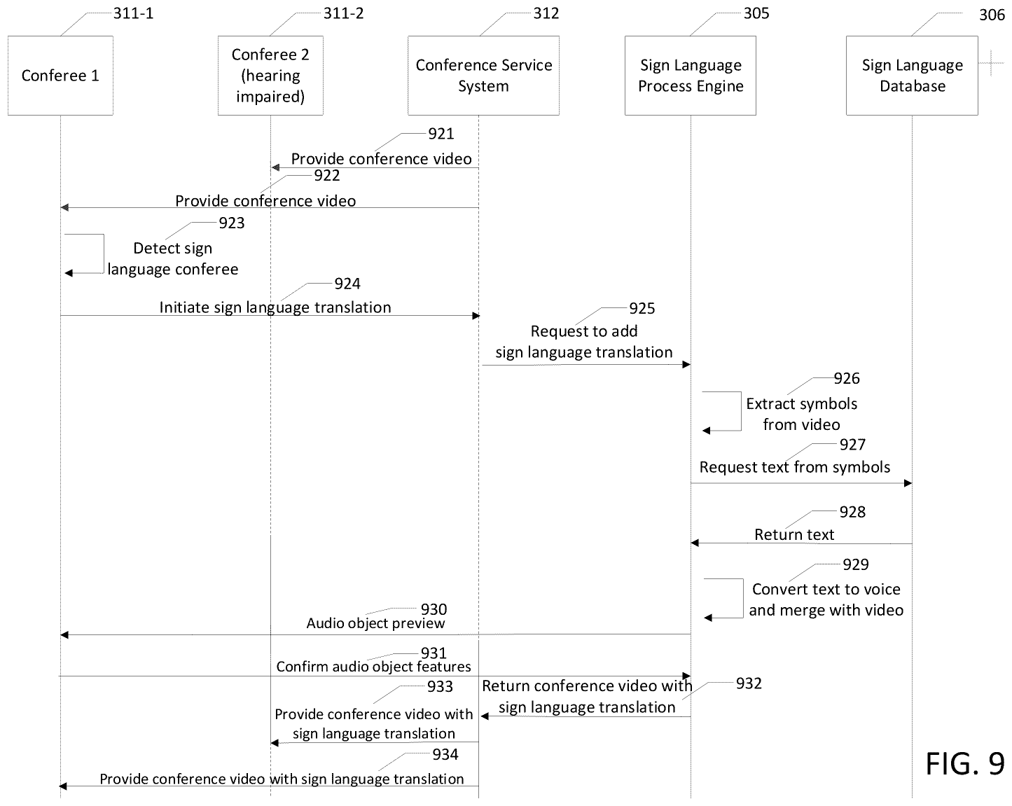

FIG. 9 shows an example of web conferencing with sign language translation. The example may be implemented by the system 310 shown in FIG. 3B. Conference service system may receive a video feed from each of conferee 1 (311-1) and conferee 2 (311-2). The example is not limiting to two conferees and the conference service system may provide the conference video to N conferees (N=>2). Conferee 2 may be associated with a hearing impaired user who may communicate via sign language in the video feed. Each video feed may comprise video and/or audio. The conference service system may combine at least a portion of video feeds from the conferees, and may generate a conference video from the combined video feeds. The combined video feeds may include identifiers of the conferees. The conference service system may provide a video object (e.g., conference video 921, 922) to the conferee 1(311-1) and the conferee 2 (311-2). The video object may comprise the video and/or audio of each video feed from each conferee. The conferee 1 (311-1) may manually or automatically detect a sign language conferee 923. The user of the conferee 1 (311-1) may manually detect sign language from the video object (e.g., viewing sign language signs). The conferee 1 (311-1) may automatically detect sign language by using NLAI. The conferee 1 (311-1) may be prompted for sign language translation if a sign language conferee is detected (e.g. conferee communicating via sign language). The conferee 1 (311-1) may send a message 924 for initiating sign language animation to the conference service system 312 if conferee 1 (311-1) selects the sign language animation. The message 924 may include a parameter indicating the source of the sign language (e.g., conferee 2 (311-2)). The conference service system 312 may generate a first request message to add sign language translation 925 and may send the first request message 925 to sign processing engine 305 after receiving the message 924. The first request message may comprise an identifier of initiator (e.g. the conferee 1 (311-1) and metadata of the video object. The metadata of the video object may comprise metadata similar to metadata 540 as described in FIG. 5D.

Sign language process engine 305 may extract sign language signs from the video object 926, and may parse the extracted sign language signs into sign language symbols. The sign language process engine 305 may retrieve the video object based on the storage location. The storage location is determined based on the first request message 925. The sign language process engine 305 may decrypt the video object using the public key if the video object is encrypted. The sign language process engine 305 may extract sign language frames from the video object based on the source parameter. The sign language process engine 305 may process video track(s) from the conferee(s) identified by the source parameter. For example, the sign language process engine 305 may process the video track from conferee 2 (311-2) and may skip the video track from conferee 1 (311-1). Based on the extracted sign language frames, the sign language process engine 305 may determine sign language signs from individual gestures, including handshape, position of hands, and/or the movement of the hands. The process engine may translate the sign language frames to sign language signs by using NLAI. The NLAI may draws on linguistic algorithms to identify sign language signals from the individual gestures of the sign language frames and may translate the sign language frames into sign language signs. The sign language frames may be in at least one of sign languages, such as American sign language (ASL), Spanish sign language (SSL), French sign language, Italian sign language, Japanese sign language, Chinese sign language, etc. The translated sign language signs may be in the same language of the sign language frames, and may be a different language from the sign language frames. The sign language process engine 305 may parse the sign language signs into sign language symbols.

Sign language process engine 305 may request a text object from the parsed sign language symbols. The sign language process engine 305 may send a second request message 927 to sign language database 306 for querying the database 306 to determine the text object, where the text object may comprise text characters. The second request message may comprise the parsed sign language symbols. The sign language database 306 may be a database of lexical and phonological properties of sign language signs. The sign language database 306 may search for the text object based on the sign language signs in the second request. The sign language database 306 may match the text object associated with at least one of sign languages (e.g., American sign language (ASL), Spanish sign language (SSL), French sign language, Italian sign language, Japanese sign language, Chinese sign language, etc.) The sign language database 306 may return the matched text object 928 to the sign language process engine 305. The sign language process engine 305 may retrieve the returned text object.

Sign language process engine 305 may convert the text object into an audio object and merge the audio object with the video object 929. The sign language process engine 305 may convert the text object to the audio object by using NLAI. The NLAI may draws on linguistic algorithms to sort text characters from the text object and may transfer the text characters into the audio object. The audio object may comprise pre-determined (e.g., default) features, wherein the features may comprise templates, avatar, overlay, closed caption, type of language, etc. The text object may be in at least one of languages, such as English, Spanish, French, Italian, Japanese, Chinese, etc. The converted audio object may be in the same language of the text object, and may be a different language from the text object. The sign language process engine 305 may merge the converted audio object with the video object. The sign language process engine 305 may replace a portion of audio track of the video object with the audio object. The merged audio object with the video object may be previewed by the initiator (conferee 1 (311-1)) via an user interface 930 (e.g., graphical user interface (GUI)), based on the identifier of the initiator from the message 925. The features of the audio object may be adjusted and confirmed by the user device 931. Based on the adjusted features, the sign language process engine 305 may modify the audio object. The sign language process engine 305 may return the video object with the modified audio object 932 to the conference service system 312. The conference service system 312 may provide the video object with the sign language translation (933, 934) based on modified audio object to the conferee 1(311-1) and the conferee 2 (311-2) respectively. The conference video (e.g. the video object) with the sign language translation in audio is presented to at least one or more users who may not understand sign language messages provided from hearing impaired users. The sign language translation allows the non-sign-language users to understand the conveyed message from the sign language video.

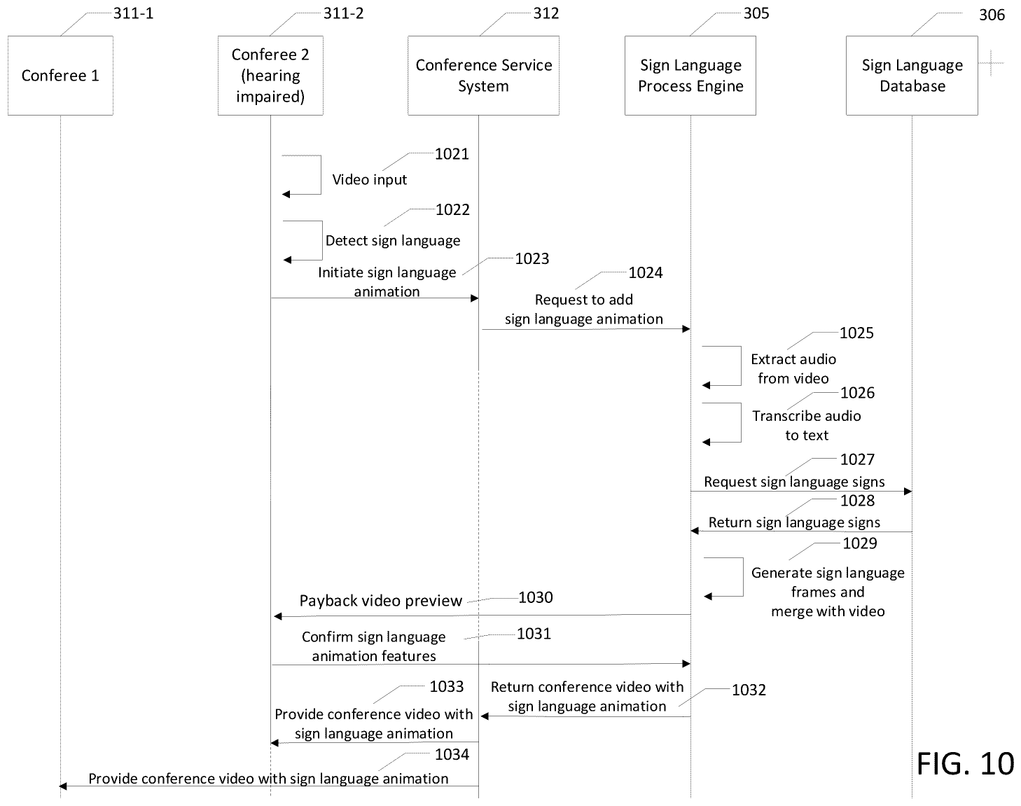

FIG. 10 shows an example of web conferencing with sign language animation. This example may be similar to the example in FIG. 8, and the sign language animation may be initiated by a hearing impaired user in this example. The example may be implemented by the system 310 shown in FIG. 3B. Conference service system may receive a video feed from each of conferee 1 (311-1) and conferee 2 (311-2). The example is not limiting to two conferees and the conference service system may provide the conference video to N conferees (N=>2). Conferee 2 may be associated with a hearing impaired user who may communicate via sign language in the video feed. Each video feed may comprise video and/or audio. The conference service system may combine at least a portion of video feeds from the conferees, and may generate a conference video from the combined video feeds. The combined video feeds may include identifiers of the conferees. The conference service system may provide a video object (e.g., conference video not shown in FIG. 10) to the conferee 1(311-1) and the conferee 2(311-2), where the video object may comprise the video and/or audio of each video feed from each conferee. The conferee 2 (311-2) may automatically detect a sign language conferee 1022 based on the video feed 1021 provided from a camera of conferee 2. The conferee 2 (311-2) may automatically detect sign language by using NLAI. The conferee 2 (311-2) may be prompted for sign language animation if a sign language is detected (e.g. conferee 2 communicating via sign language). The conferee 2 (311-2) may send a message 1023 for initiating sign language animation to the conference service system 312 if conferee 2 (311-2) selects the sign language animation. The message 1023 may include a parameter indicating the source of the sign language (e.g., conferee 2 (311-2)). The conference service system 312 may generate a first request message to add sign language animation 1024 and may send the first request message 1024 to sign processing engine 305 after receiving the message 1023. The first request message may comprise an identifier of initiator (e.g., the conferee 2 (311-2)) and metadata of the video object. The metadata of the video object may comprise metadata similar to metadata 540 as described in FIG. 5D.

Sign language process engine 305 may extract an audio object from the video object 1025 and may transcribe the audio object to a text object 1026. The sign language process engine 305 may retrieve the video object based on the storage location. The storage location is determined based on the first request message 1024. The sign language process engine 305 may decrypt the video object using the public key if the video object is encrypted. The sign language process engine 305 may extract the audio object from the video object by separating an audio track from the video object based on the source parameter. The sign language process engine 305 may skip the audio track from the conferee(s) identified by the source parameter. For example, the sign language process engine 305 may skip the audio track from conferee 2 (311-2) and may extract the audio track from conferee 1 (311-1). The process engine may transcribe the audio object to a text object by using NLAI. The NLAI may draws on linguistic algorithms to sort auditory signals from the audio object and may transfer auditory signals into a text object, where the text object may comprise text characters. The audio object may be in at least one of languages, such as English, Spanish, French, Italian, Japanese, Chinese, etc. The transcribed text object may be in the same language of the audio object, and may be a different language from the audio object.

Sign language process engine 305 may request sign language symbols from the text object. The process engine may send a second request message 1027 to sign language database 306 for querying the database 306 to determine the sign language symbols. The second request message may comprise the transcribed text object. The database 306 may be a database of lexical and phonological properties of sign language signs. The database 306 may search for the sign language symbols based on the text object in the second request. The database 306 may match the sign language symbols associated with at least one of sign languages (e.g., American sign language (ASL), Spanish sign language (SSL), French sign language, Italian sign language, Japanese sign language, Chinese sign language, etc.) The database 306 may return the matched sign language symbols 1029 to the sign language process engine 305.

Sign language process engine 305 may generate sign language animated frames based on the received sign language symbols. The sign language animated frames may comprise pre-determined (e.g., default) features wherein the features may comprise templates, avatar, overlay, closed caption, type of sign language, etc. The process engine may merge the sign language animated frames with the video object. The merged sign language animated frames with the video object may be previewed 1030 by the initiator (e.g., the conferee 2 (311-2)) via an user interface (e.g., graphical user interface (GUI)), based on the identifier of the initiator from the message 1024. The features of the sign language animated frames may be adjusted and confirmed 1031 by the conferee 2 (311-2). Based on the adjusted and confirmed features, the sign language process engine 305 may modify the sign language animated frames. The sign language process engine 305 may return the video object with the modified sign language animation 1032 to the conference service system 312. The conference service system may provide the video object with the modified sign language animation (1034, 1033) to the conferee 1(311-1) and the conferee 2 (311-2) respectively. The video object with the sign language animation is presented to at least one or more hearing impaired users (e.g., the conferee 2 (311-2)) through the system wherein generating the sign language animation is initiated by the one or more hearing impaired users. The sign language animation allows the hearing impaired users to understand conveyed messages from the web conference.

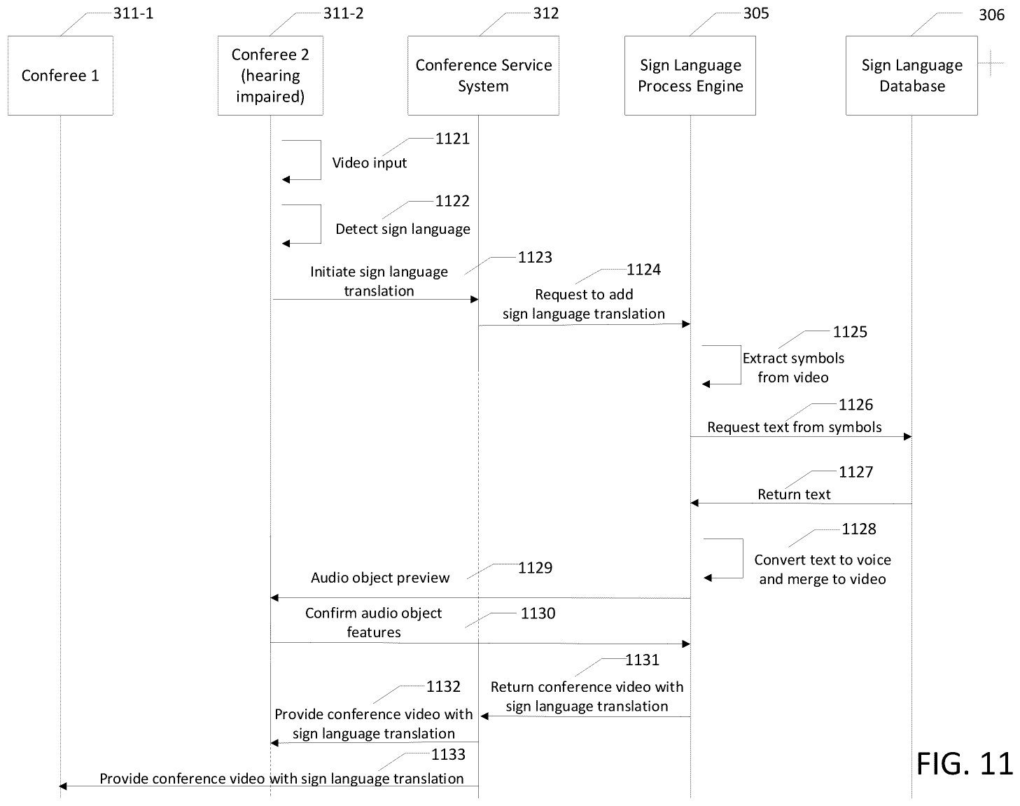

FIG. 11 shows an example of web conferencing with sign language translation. This example may be similar to the example in FIG. 9, and the sign language animation may be initiated by a hearing impaired user in this example. The example may be implemented by the system 310 shown in FIG. 3B. Conference service system may receive a video feed from each of conferee 1 (311-1) and conferee 2 (311-2). The example is not limiting to two conferees and the conference service system may provide the conference video to N conferees (N=>2). Conferee 2 may be associated with a hearing impaired user who may communicate via sign language in the video feed. Each video feed may comprise video and/or audio. The conference service system may combine at least a portion of video feeds from the conferees, and may generate a conference video from the combined video feeds. The combined video feeds may include identifiers of the conferees. The conference service system may provide a video object (e.g., conference video not shown in FIG. 11) to the conferee 1(311-1) and the conferee 2 (311-2). The video object may comprise the video and/or audio of each video feed from each conferee. The conferee 2 (311-1) may automatically detect a sign language conferee 1122 based on the video feed 1021 provided from a camera of conferee 2. The conferee 2 (311-2) may automatically detect sign language by using NLAI. The conferee 2 (311-2) may be prompted for sign language translation if a sign language conferee is detected (e.g. conferee communicating via sign language). The conferee 2 (311-2) may send a message 1123 for initiating sign language animation to the conference service system 312 if conferee 2 (311-2) selects the sign language animation. The message 1124 may include a parameter indicating the source of the sign language (e.g., conferee 2 (311-2)). The conference service system 312 may generate a first request message to add sign language translation 1124 and may send the first request message 1124 to sign processing engine 305 after receiving the message 1123. The first request message 1124 may comprise an identifier of initiator (e.g. the conferee 1 (311-1)) and metadata of the video object. The metadata of the video object may comprise metadata similar to metadata 540 as described in FIG. 5D.

Sign language process engine 305 may extract sign language signs from the video object, and may parse the extracted sign language signs into sign language symbols 1125. The sign language process engine 305 may retrieve the video object based on the storage location. The storage location is determined based on the first request message 1124. The sign language process engine 305 may decrypt the video object using the public key if the video object is encrypted. The sign language process engine 305 may extract sign language frames from the video object based on the source parameter. The sign language process engine 305 may process video track(s) from the conferee(s) identified by the source parameter. For example, the sign language process engine 305 may process the video track from conferee 2 (311-2) and may skip the video track from conferee 1 (311-1). Based on the extracted sign language frames, the sign language process engine 305 may determine sign language signs from individual gestures, including handshape, position of hands, and/or the movement of the hands. The process engine may translate the sign language frames to sign language signs by using NLAI. The NLAI may draws on linguistic algorithms to identify sign language signals from the individual gestures of the sign language frames and may translate the sign language frames into sign language signs. The sign language frames may be in at least one of sign languages, such as American sign language (ASL), Spanish sign language (SSL), French sign language, Italian sign language, Japanese sign language, Chinese sign language, etc. The translated sign language signs may be in the same language of the sign language frames, and may be a different language from the sign language frames. The sign language process engine 305 may parse the sign language signs into sign language symbols.

Sign language process engine 305 may request a text object from the parsed sign language symbols. The sign language process engine 305 may send a second request message 1126 to sign language database 306 for querying the database 306 to determine the text object, where the text object may comprise text characters. The second request message may comprise the parsed sign language symbols. The sign language database 306 may be a database of lexical and phonological properties of sign language signs. The sign language database 306 may search for the text object based on the sign language signs in the second request. The sign language database 306 may match the text object associated with at least one of sign languages (e.g., American sign language (ASL), Spanish sign language (SSL), French sign language, Italian sign language, Japanese sign language, Chinese sign language, etc.) The sign language database 306 may return the matched text object 1127 to the sign language process engine 305. The sign language process engine 305 may retrieve the returned text object.

Sign language process engine 305 may convert the text object into an audio object and merge the audio object with the video object 1128. The sign language process engine 305 may convert the text object to the audio object by using NLAI. The NLAI may draws on linguistic algorithms to sort text characters from the text object and may transfer the text characters into the audio object. The audio object may comprise pre-determined (e.g., default) features, wherein the features may comprise templates, avatar, overlay, closed caption, type of language, etc. The text object may be in at least one of languages, such as English, Spanish, French, Italian, Japanese, Chinese, etc. The converted audio object may be in the same language of the text object, and may be a different language from the text object. The sign language process engine 305 may merge the converted audio object with the video object. The sign language process engine 305 may replace a portion of audio track of the video object with the audio object. The merged audio object with the video object may be previewed by the initiator (e.g., conferee 2 (311-2)) via an user interface 1129 (e.g., graphical user interface (GUI)), based on the identifier of the initiator from the message 1124. The features of the audio object may be adjusted and confirmed by the user device 1130. Based on the adjusted features, the sign language process engine 305 may modify the audio object. The sign language process engine 305 may return the video object with the modified audio object 1131 to the conference service system 312. The conference service system 312 may provide the video object with the sign language translation (1133, 1132) based on modified audio object to the conferee 1(311-1) and the conferee 2 (311-2) respectively. The conference video (e.g. the video object) with the sign language translation in audio is presented to at least one or more users who may not understand sign language messages provided from hearing impaired users. The sign language translation allows the non-sign-language users to understand the conveyed message from the sign language video.

The examples from FIG. 8, FIG. 9, FIG. 10 and FIG. 11 are not limiting to occur independently. The examples from FIG. 8, FIG. 9, FIG. 10 and FIG. 11 may occur concurrently in a web conference session. For example, conferee 1 (311-1) from FIG. 8 and FIG. 9 may initiate sign language animation and may initiate sign language translation concurrently in a same web conferencing session. Conferee 2 (311-2) from FIG. 10 and FIG. 11 may initiate sign language animation and may initiate sign language translation concurrently in a same web conferencing session.

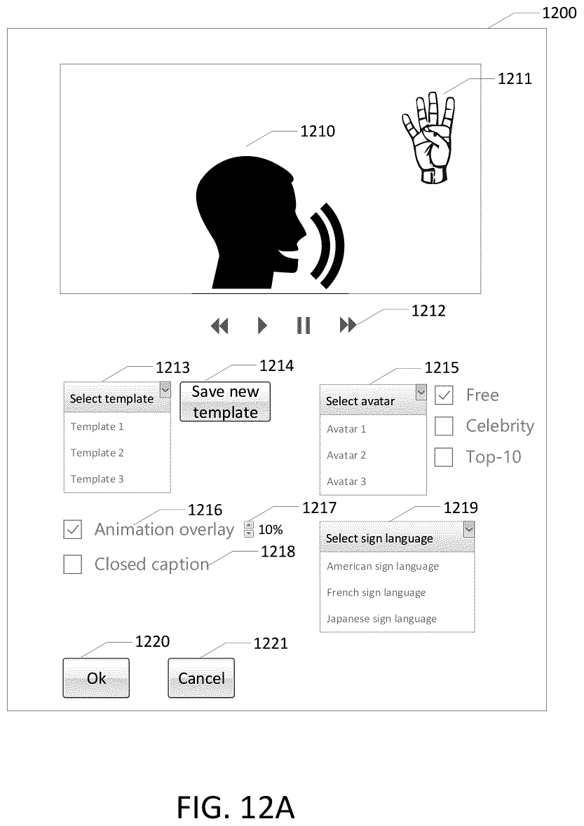

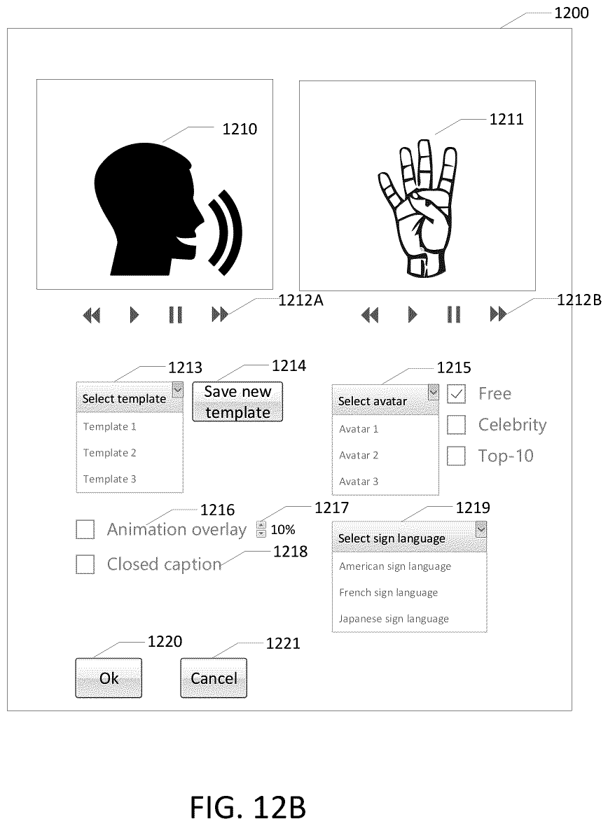

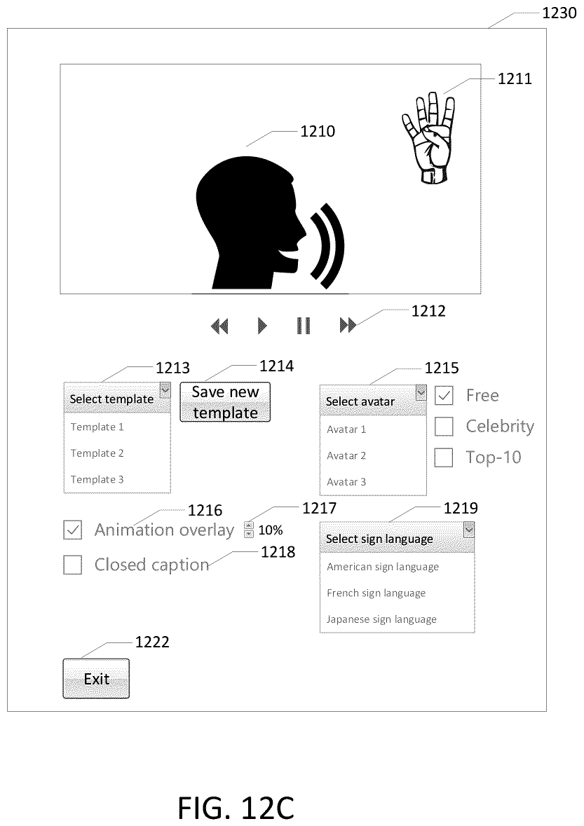

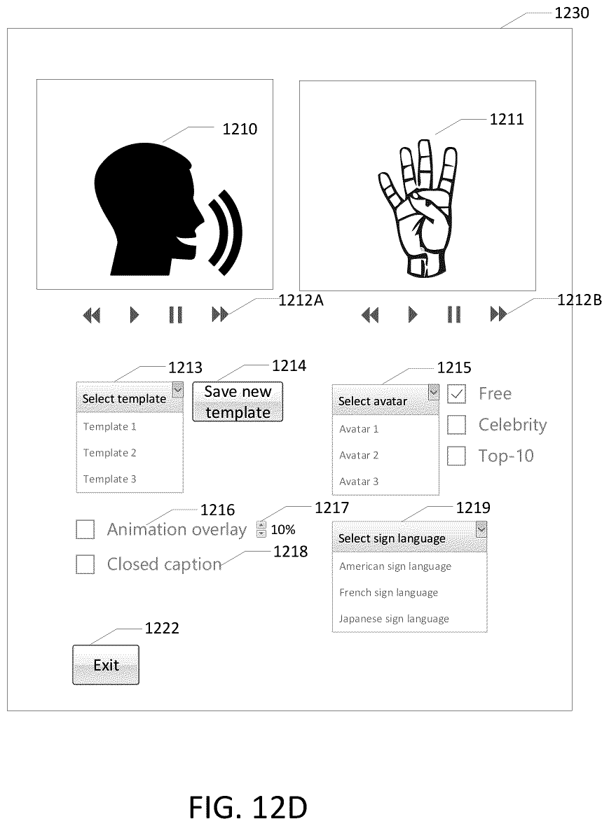

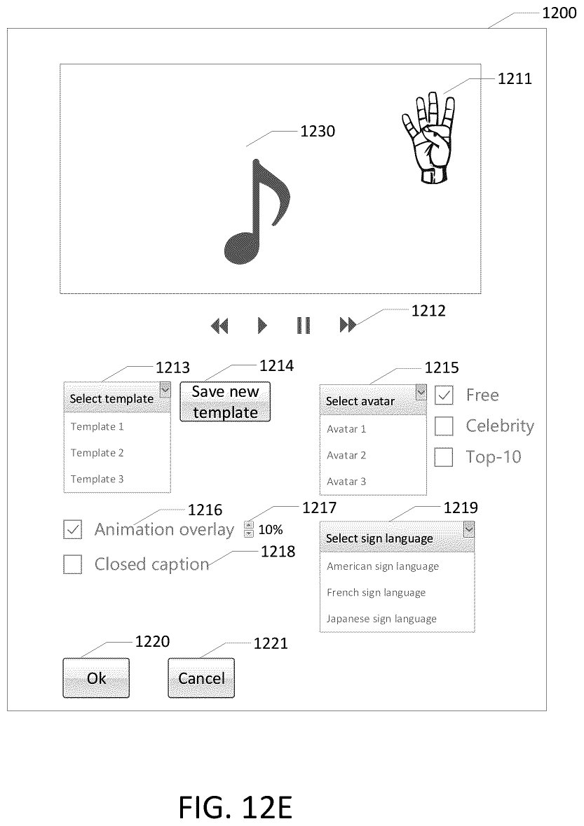

FIG. 12A shows an example of video voicemail with sign language animation preview. GUI 1200 as shown in FIG. 12A may comprise multiple elements (e.g., elements 1210, 1211, 1212, 1213, 1214, 1215, 1216, 1217, 1218, 1219, 1220, 1221). GUI 1200 may present a preview of video voicemail and sign language animation to the caller 301 in 641. Video feed 1210 may show the video voicemail generated by the caller 301, and sign language animation 1211 may show the sign language animated frames associated with the video voicemail. Playback control 1212 may allow the caller 641 control the playback of the video voicemail merged with the sign language animated frames (e.g., start, stop, pause, 2× speed, ½× speed, fast forward, fast backward, etc.). Template selection 1213 may be a drop-down list, and may allow the caller 641 selecting an existing template, wherein a template may comprise a selection of feature parameters, such as avatar, animation overlay, closed caption, sign language, etc. The caller 641 may click on button 1214 for saving a selection of feature parameters as a new template. Avatar selection 1215 may comprise a drop-down list and/or check boxes, and may allow the caller 641 choosing an avatar of the sign language animation. The checkboxes may allow showing a category of avatars (e.g., free, celebrity, top-10). Free avatars (no fee to caller 641) may show at the drop-down list if the free category is selected (e.g., by checking the “Free” check box). Celebrity avatars may show at the drop-down list if the celebrity category is selected (e.g., by checking the “Celebrity” check box). The celebrity avatars (if selected) may result a fee to caller 641. The ten-most popular avatars may show at the drop-down list if the top-10 category is selected (e.g., by checking the “Top-10” check box). Overlay selection 1216 may be a checkbox and may allow the sign language animation overlaying with the video feed. The caller 641 may select the overlay percentage with overlay control 1217. Closed caption selection 1218 may a checkbox, and may allow displaying closed caption associated with the video feed 1210. Sign language selection 1219 may be a dropdown list and may allow a selection of sign languages (e.g., American sign language (ASL), Spanish sign language (SSL), French sign language, Italian sign language, Japanese sign language, Chinese sign language, etc.) The caller 641 may click on button 1220 to confirm the sign language animation feature parameters. The caller 641 may click on button 1221 to terminate adding sign language animation to the video feed. The example GUI 1200 may present default features of sign language animation and may allow users (e.g., caller 641) modifying for desired features.

FIG. 12B shows an example of video voicemail with sign language animation preview. FIG. 12B is a similar example to FIG. 12A. Elements 1213, 1214, 1215, 1216, 1217, 1218, 1219, 1220, 1221 on FIG. 12B are identical to respective elements on FIG. 12A. GUI 1200 may show separate displays of video feed 1210 and video animation 1211 if the overlay selection 1216 is un-selected. Separate playback control 1212A and 1212B may correspond to video feed 1210 and the sign language animation 1211 respectively.

FIG. 12C shows an example of playing video voicemail with sign language animation to a hearing impaired user. Elements 1210, 1211, 1212, 1213, 1214, 1215, 1216, 1217, 1218 and 1219 on FIG. 12C are identical on respective elements on FIG. 12A. GUI 1230 may present to a hearing impaired user (e.g., callee 304) after 644. GUI 1230 may allow the hearing impaired user modifying the features of sign language animation during the time of playing the video voicemail with the sign language animation. The hearing impaired user may click button 1222 to end the playing of the video voicemail with the sign language animation.

FIG. 12D shows an example of playing video voicemail with sign language animation to a hearing impaired user. Elements 1213, 1214, 1215, 1216, 1217, 1218, 1219 and 1222 are identical on FIG. 12C. GUI 1230 may present to a hearing impaired user (e.g., callee 304) after 644. GUI 1230 may show separate displays of video feed 1210 and video animation 1211 if the overlay selection 1216 is un-selected. Separate playback control 1212A and 1212B may correspond to video feed 1210 and the video animation 1211 respectively.

FIG. 12E shows an example of audio voicemail with sign language animation preview. FIG. 12E is a similar example to FIG. 12A. Elements 1213, 1214, 1215, 1216, 1217, 1218, 1219, 1220, 1221 on FIG. 12E are identical to respective elements on FIG. 12A. GUI 1200 may show separate displays of audio feed 1210 and video animation 1211 if the overlay selection 1216 is selected. The audio feed 1210 may show an icon indicating a playing audio.

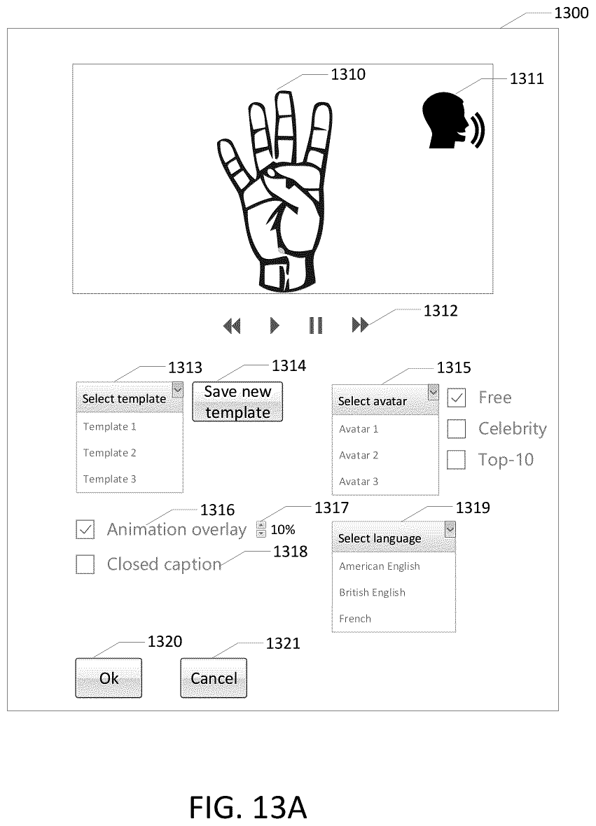

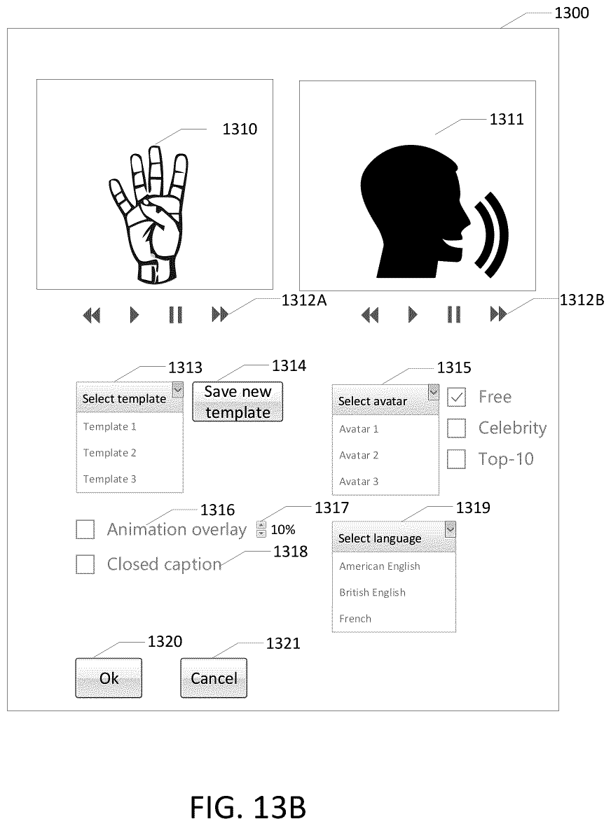

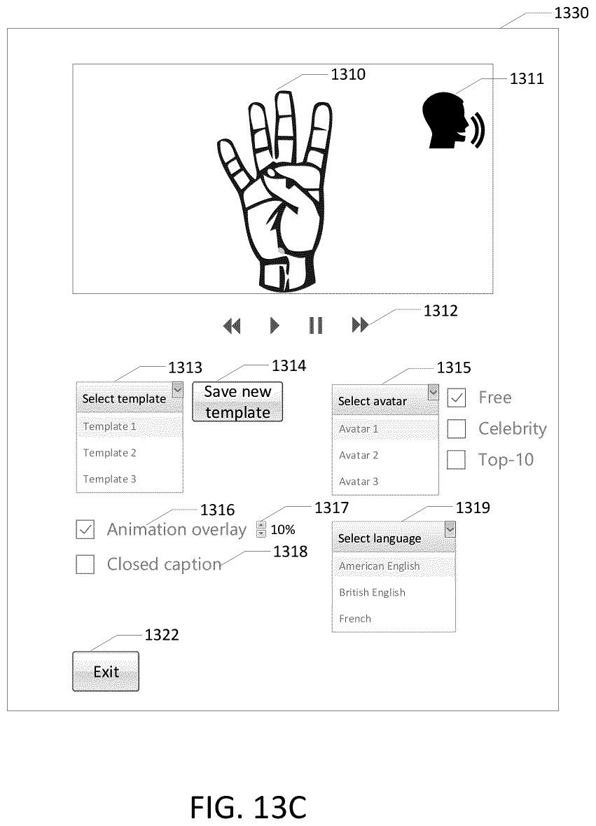

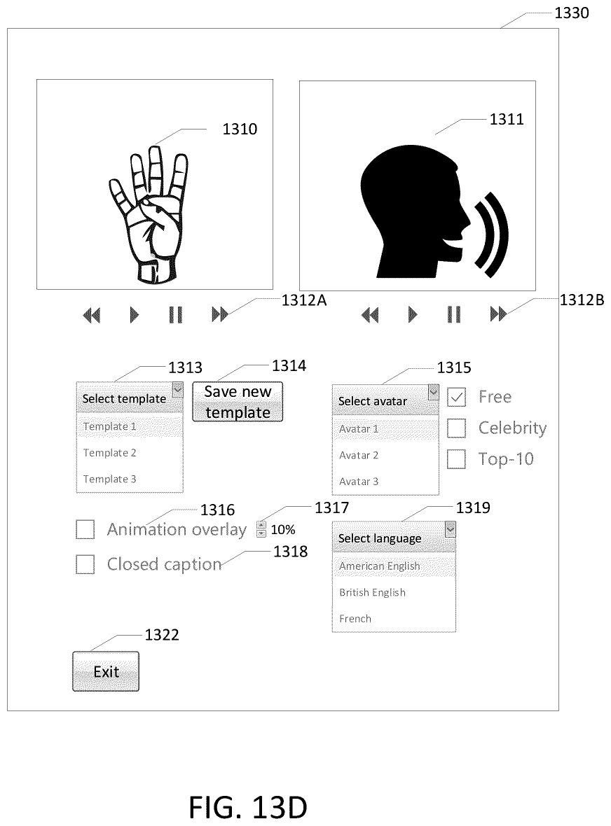

FIG. 13A shows an example of video voicemail with sign language translation preview. GUI 1300 as shown in FIG. 13A may comprise multiple elements (e.g., elements 1310, 1311, 1312, 1313, 1314, 1315, 1316, 1317, 1318, 1319, 1320, 1321). GUI 1300 may present a preview of video voicemail and sign language translation to the caller 301 in 741. Video feed 1310 may comprise sign language signs, and may show the video voicemail generated by the caller 301. Sign language translation 1311 may comprise an avatar playing an audio of sign language translation associated with the video voicemail. Playback control 1312 may allow the caller 641 control the playback of the video voicemail merged with the sign language translation (e.g., start, stop, pause, 2× speed, ½× speed, fast forward, fast backward, etc.). Template selection 1313 may be a drop-down list, and may allow the caller 641 selecting an existing template, wherein a template may comprise a selection of feature parameters, such as avatar, animation overlay, closed caption, language, etc. The caller 641 may click on button 1314 for saving a selection of feature parameters as a new template. Avatar selection 1315 may comprise a drop-down list and/or check boxes, and may allow the caller 641 choosing an avatar of the sign language animation. The checkboxes may allow showing a category of avatars (e.g., free, celebrity, top-10). Free avatars (no fee to caller 641) may show at the drop-down list if the free category is selected (e.g., by checking the “Free” check box). Celebrity avatars may show at the drop-down list if the celebrity category is selected (e.g., by checking the “Celebrity” check box). The celebrity avatars (if selected) may result a fee to caller 641. The ten-most popular avatars may show at the drop-down list if the top-10 category is selected (e.g., by checking the “Top-10” check box). Overlay selection 1316 may be a checkbox and may allow the sign language translation overlaying with the video feed. The caller 641 may select the overlay percentage with overlay control 1317. Closed caption selection 1318 may a checkbox, and may allow displaying closed caption associated with the sign language translation 1311. Language selection 1319 may be a dropdown list and may allow a selection of languages (e.g., American English, British English, French, Spanish, Italian, Japanese, Chinese, etc.) The caller 641 may click on button 1320 to confirm the sign language translation feature parameters. The caller 641 may click on button 1321 to terminate adding sign language translation to the video feed. The example GUI 1300 may present default features of sign language translation and may allow users (e.g., caller 641) modifying for desired features.

FIG. 13B shows an example of video voicemail with sign language translation preview. FIG. 13B is a similar example to FIG. 13A. Elements 1313, 1314, 1315, 1316, 1317, 1318, 1319, 1320, 1321 on FIG. 13B are identical to respective elements on FIG. 13A. GUI 1300 may show separate displays of video feed 1310 and video animation 1311 if the overlay selection 1316 is un-selected. Separate playback control 1312A and 1312B may correspond to video feed 1310 and the sign language translation 1311 respectively.

FIG. 13C shows an example of playing video voicemail with sign language translation to a non-hearing impaired user. Elements 1310, 1311, 1312, 1313, 1314, 1315, 1316, 1317, 1318 and 1319 on FIG. 13C are identical on respective elements on FIG. 13A. GUI 1330 may present to a non-hearing impaired user (e.g., callee 304) after 744. GUI 1330 may allow the non-hearing impaired user modifying the features of sign language translation during the time of playing the video voicemail with the sign language translation. The non-hearing impaired user may click button 1322 to end the playing of the video voicemail with the sign language translation.

FIG. 13D shows an example of playing video voicemail with sign language translation to a non-hearing impaired user. Elements 1313, 1314, 1315, 1316, 1317, 1318, 1319 and 1322 on FIG. 13D are identical to respective elements on FIG. 13C. GUI 1330 may present to a non-hearing impaired user (e.g., callee 304) after 744. GUI 1330 may show separate displays of video feed 1310 and sign language translation 1311 if the overlay selection 1316 is un-selected. Separate playback control 1312A and 1312B may correspond to video feed 1310 and the sign language translation 1311 respectively.

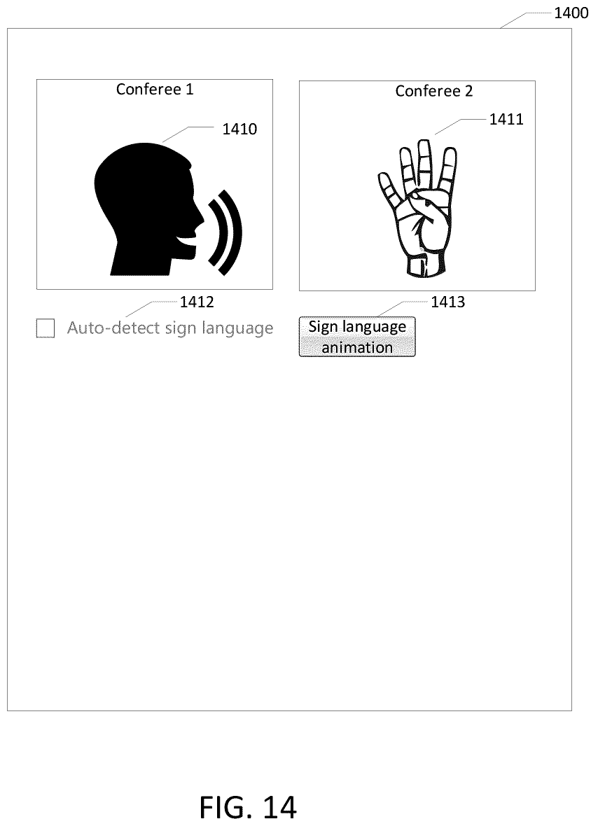

FIG. 14 shows an example of detecting sign language in 823 or 1022. GUI 1400 may be running at conferee 1 (311-1) in 823. GUI 1400 may be running at conferee 2 (311-2) in 1022. GUI 1400 may display video feeds (1410, 1411) of conferee 1 (311-1) and conferee 2 (311-2). Sign language may be detected automatically if box 1412 is checked. The sign language may automatically detected by using NLAI. Sign language may be detected manually if button 1413 is checked.

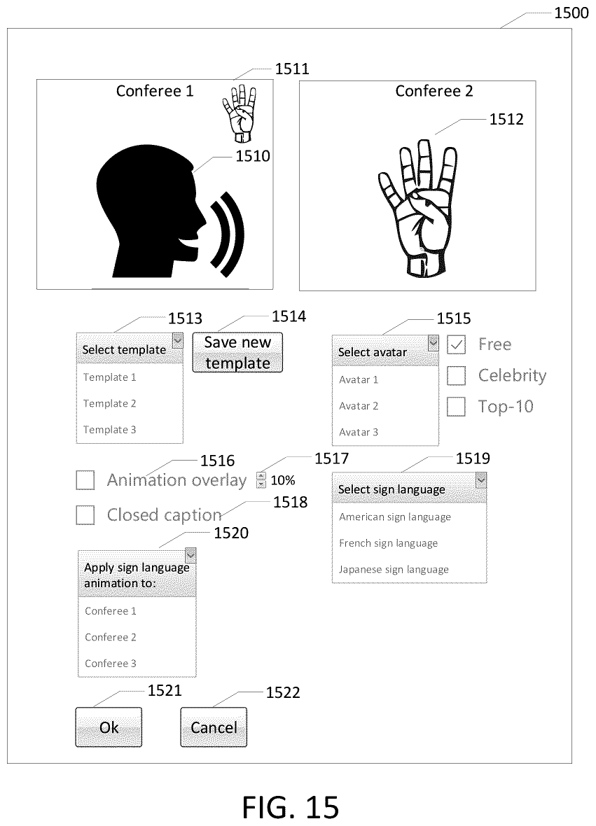

FIG. 15 shows an example of the preview of web conference video with sign language animation in 831 or 1030. GUI 1500 may be running at conferee 1 (311-1) in 831. GUI 1500 may be running at conferee 2 (311-2) in 1030. Although FIG. 15 is showing an example for two conferees, it is not limiting to only two conferees. For example, GUI 1500 may accommodate more than two conferees. GUI 1500 as shown in FIG. 15 may comprise multiple elements (e.g., elements 1510, 1511, 1512, 1513, 1514, 1515, 1516, 1517, 1518, 1519, 1520, 1521, 1522). Video feed 1510 may show conference video generated by the conferee 1 (311-1), and sign language animation 1511 may show the sign language animated frames associated with the video feed 1510. Video feed 1512 may show conference video generated by the conferee 2 (311-2). Template selection 1513 may be a drop-down list, and may allow the conferee 1 (311-1) or the conferee 2 (311-2) selecting an existing template, wherein a template may comprise a selection of features, such as avatar, animation overlay, closed caption, sign language, etc. The conferee 1 (311-1) or the conferee 2 (311-2) may click on button 1514 for saving a selection of features as a new template. Avatar selection 1515 may comprise a drop-down list and/or check boxes, and may allow the conferee 1 (311-1) or the conferee 2 (311-2) choosing an avatar of the sign language animation. The checkboxes may allow showing a category of avatars (e.g., free, celebrity, top-10). Free avatars (no fee to the conferee 1 (311-1) or the conferee 2 (311-2)) may show at the drop-down list if the free category is selected (e.g., by checking the “Free” check box). Celebrity avatars may show at the drop-down list if the celebrity category is selected (e.g., by checking the “Celebrity” check box). The celebrity avatars (if selected) may result a fee to the conferee 1 (311-1) or the conferee 2 (311-2). The ten-most popular avatars may show at the drop-down list if the top-10 category is selected (e.g., by checking the “Top-10” check box). Overlay selection 1516 may be a checkbox and may allow the sign language animation overlaying with the video feed. The conferee 1 (311-1) or the conferee 2 (311-2) may select the overlay percentage with overlay control 1517. Closed caption selection 1518 may a checkbox, and may allow displaying closed caption associated with the video feed 1510. Sign language selection 1519 may be a dropdown list and may allow a selection of sign languages (e.g., American sign language (ASL), Spanish sign language (SSL), French sign language, Italian sign language, Japanese sign language, Chinese sign language, etc.) Dropdown list 1520 may select which video feed should be applied for sign language animation. For example, the video feed from conferee 1 is picked for sign language animation if conferee 1 is selected from the dropdown list. The conferee 1 (311-1) or the conferee 2 (311-2) may click on button 1521 to confirm the sign language animation features. The conferee 1 (311-1) or the conferee 2 (311-2) may click on button 1522 to terminate adding sign language animation to the video feed. The example GUI 1500 may present default features of sign language animation and may allow users (e.g., the conferee 1 (311-1) or the conferee 2 (311-2)) modifying for desired features.

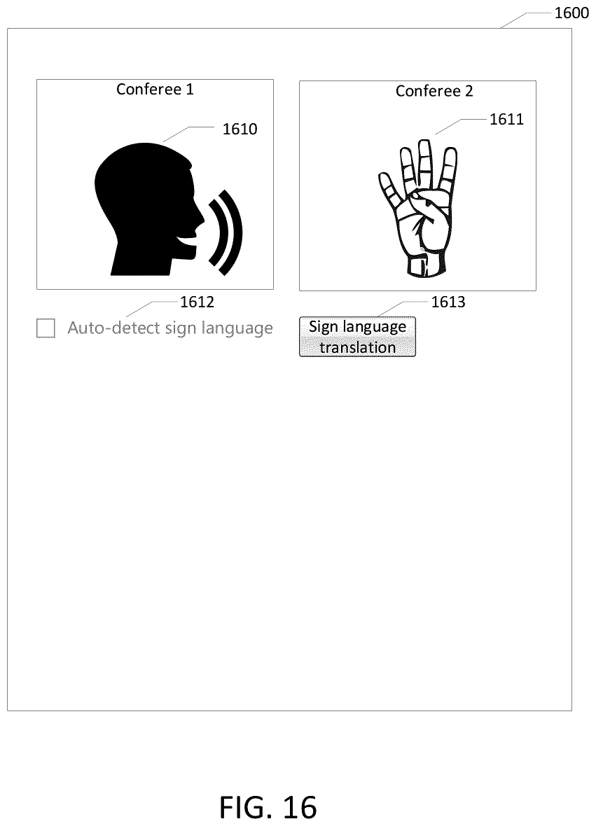

FIG. 16 shows an example of detecting sign language in 923 or 1122. GUI 1600 may be running at conferee 1 (311-1) in 923. GUI 1600 may be running at conferee 2 (311-2) in 1122. GUI 1600 may display video feeds (1610, 1611) of conferee 1 (311-1) and conferee 2 (311-2). Sign language may be detected automatically if box 1612 is checked. The sign language may automatically detected by using NLAI. Sign language may be detected manually if button 1613 is checked.

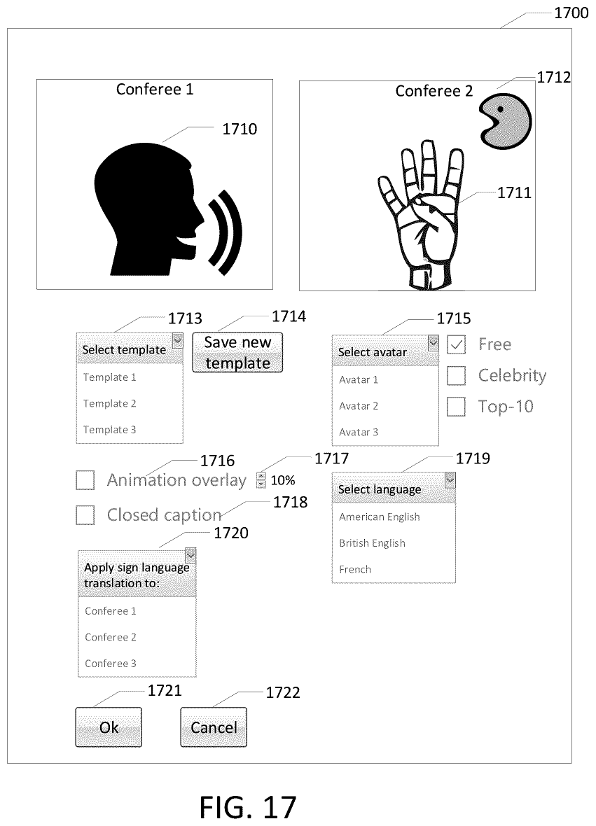

FIG. 17 shows an example of the preview of web conference video with sign language translation in 930 or 1129. GUI 1700 may be running at conferee 1 (311-1) in 930. GUI 1700 may be running at conferee 2 (311-2) in 1129. Although FIG. 17 is showing an example for two conferees, it is not limiting to only two conferees. For example, GUI 1700 may accommodate more than two conferees. GUI 1700 as shown in FIG. 17 may comprise multiple elements (e.g., elements 1710, 1711, 1712, 1713, 1714, 1715, 1716, 1717, 1718, 1719, 1720, 1721, 1722). Video feed 1710 may show conference video generated by the conferee 1 (311-1). Video feed 1711 may show conference video generated by the conferee 2 (311-2), and sign language translation 1712 may show the sign language translation associated with the video feed 1711. Template selection 1713 may be a drop-down list, and may allow the conferee 1 (311-1) or the conferee 2 (311-2) selecting an existing template, wherein a template may comprise a selection of features, such as avatar, animation overlay, closed caption, sign language, etc. The conferee 1 (311-1) or the conferee 2 (311-2) may click on button 1714 for saving a selection of features as a new template. Avatar selection 1715 may comprise a drop-down list and/or check boxes, and may allow the conferee 1 (311-1) or the conferee 2 (311-2) choosing an avatar of the sign language animation. The checkboxes may allow showing a category of avatars (e.g., free, celebrity, top-10). Free avatars (no fee to the conferee 1 (311-1) or the conferee 2 (311-2)) may show at the drop-down list if the free category is selected (e.g., by checking the “Free” check box). Celebrity avatars may show at the drop-down list if the celebrity category is selected (e.g., by checking the “Celebrity” check box). The celebrity avatars (if selected) may result a fee to the conferee 1 (311-1) or the conferee 2 (311-2). The ten-most popular avatars may show at the drop-down list if the top-10 category is selected (e.g., by checking the “Top-10” check box). Overlay selection 1716 may be a checkbox and may allow the sign language animation overlaying with the video feed. The conferee 1 (311-1) or the conferee 2 (311-2) may select the overlay percentage with overlay control 1717. Closed caption selection 1718 may a checkbox, and may allow displaying closed caption associated with the video feed 1711. Language selection 1719 may be a dropdown list and may allow a selection of sign languages (e.g., American English, British English, French, Spanish, Italian, Japanese, Chinese, etc.) Dropdown list 1720 may select which video feed should be applied for sign language translation. For example, the video feed from conferee 2 is picked for sign language translation if conferee 2 is selected from the dropdown list. The conferee 1 (311-1) or the conferee 2 (311-2) may click on button 1721 to confirm the sign language animation features. The conferee 1 (311-1) or the conferee 2 (311-2) may click on button 1722 to terminate adding sign language animation to the video feed. The example GUI 1700 may present default features of sign language translation and may allow users (e.g., the conferee 1 (311-1) or the conferee 2 (311-2)) modifying for desired features.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting. US CLAIMS

What is claimed is:

1. A method comprising:
receiving a first request for a sign language animation associated with a video object, wherein the video object is associated with metadata;
determining, based on the metadata associated with the video object, an audio object;
transcribing the audio object to a text object;
determining, based on the text object, one or more sign language symbols associated with the text object; and
sending, based on the determined sign language symbols, the video object with a sign language animation.

2. The method of claim 1, wherein receiving the first request includes:
receiving, by a sign language process engine and based on a response from a user, the first request from a voicemail system or a conference service system.

3. The method of claim 2, wherein the response from the user comprises an identifier of a user device.

4. The method of claim 1, wherein the metadata comprises at least one of:
a length of the video object;
a storage location of the video object; or
a public key associated with the video object.

5. The method of claim 1, wherein the method further comprises:
querying a database to determine the one or more sign language symbols associated with the text object by sending, based on the text object and to the database, a second request for the sign language symbols.

6. The method of claim 1, wherein the sending the video object with the sign language animation further comprises:
generating, based on the determined sign language symbols, sign language animation; and
embedding the generated sign language animation with the video object.

7. The method of claim 1, where the video object comprises at least one of:
a video voice mail;
a pre-recorded video; or
a live video.

8. The method of claim 1, wherein the method further comprises:
generating, based on the determined sign language symbols, sign language animation.

9. A method comprising:
receiving a first request for a sign language translation associated with a first video object, wherein the first video object comprises metadata;
determining, based on the metadata associated with the first video object, one or more first sign language symbols;
determining, based on the one or more first sign language symbols, a first text object;
converting the determined first text object to a first audio object; and
sending the first video object with the first audio object.

10. The method of claim 9, further comprising:
receiving, by a service device, a second request for a sign language animation associated with a second video object, wherein the second video object is associated with a second metadata;
determining, based on the second metadata associated with the second video object, a second audio object;
transcribing the second audio object to a second text object;
determining, based on the second text object, one or more second sign language symbols associated with the second text object; and
sending, based on the determined second sign language symbols, the second video object with the sign language animation.

11. The method of claim 9, wherein the first video object comprises at least one of:
a video voice mail;
a pre-recorded video; or
a live video.

12. The method of claim 9, further comprising:
the receiving of the first request is based on an automatic detection of sign language in the first video object.

13. A method comprising:
receiving a first request for a sign language animation associated with an audio object, wherein the audio object is associated with metadata;
determining, based on the metadata associated with the audio object, the audio object;
transcribing the audio object to a text object;
determining, based on the text object, one or more sign language symbols associated with the text object; and
sending, based on the determined sign language symbols, the audio object with the sign language animation.

14. The method of claim 13, wherein the audio object comprises at least one of:
an audio voice mail;
a pre-recorded audio; or
a live audio.

15. The method of claim 13, wherein the first request comprises an identifier of a user device; and the method further comprising:
providing, based on the identifier of the user device, a graphical user interface (GUI) with at least one or more feature parameters, wherein a user selects the at least one or more feature parameters;
processing, based on the one or more feature parameters, the sign language animation; and
sending the audio object with the processed sign language animation.

16. The method of claim 15, wherein the one or more processing parameters comprises at least one of:
an identifier of a template;
an identifier of an avatar;
a type of sign language;
an overlay percentage; or
a closed-caption option.

17. The method of claim 16, wherein the avatar is associated with the sign language animation, and the avatar comprises at least one of type of fee, celebrity or popularity.

18. The method of claim 15, wherein the GUI provides, based on the one or more feature parameters, a preview of the sign language animation.

19. The method of claim 15, wherein the one or more feature parameters, via the GUI and by the user, are saved in a template.

20. The method of claim 15, wherein the GUI provides a preview of the audio object at a pre-determined speed, and a preview of the sign language animation at a different speed than the pre-determined speed.
